(19) United States
(12) Patent Application Publication
(10) Pub. No.: US 2025/0247696 A1
(43) Pub. Date: Jul. 31, 2025

(54) AUTHENTICATION FOR DISTRIBUTED NON-ACCESS STRATUM

(71) Applicant: Apple Inc., Cupertino, CA (US)

(72) Inventors: Shu Guo, Beijing (CN); Huarui Liang, Beijing (CN); Dawei Zhang, Saratoga, CA (US); Haijing Hu, Los Gatos, CA (US); Behrouz Aghili, San Diego, CA (US); Ralf Rossbach, Munich (DE); Sudeep Manithara Vamanan, Nuremberg (DE); Fangli Xu, Beijing (CN)

(73) Assignee: Apple Inc., Cupertino, CA (US)

(21) Appl. No.: 19/006,781

(22) Filed: Dec. 31, 2024

Related U.S. Application Data
(60) Provisional application No. 63/627,726, filed on Jan. 31, 2024.

(51) Int. Cl. H04W 12/06

(52) U.S. Cl. CPC H04W 12/06

(57) ABSTRACT

The present application relates to devices and components including apparatus, systems, and methods to perform authentication procedures for direct non-access stratum (NAS) connections in a network.

### CROSS-REFERENCE TO RELATED APPLICATION

This application claims priority to U.S. Provisional Patent Application No. 63/627,726, entitled “Authentication for Distributed Non-access Stratum,” filed on Jan. 31, 2024, the disclosure of which is incorporated by reference herein in its entirety for all purposes.

### TECHNICAL FIELD

The present application relates to the field of wireless technologies and, in particular, to authentication for distributed non-access stratum arrangements.

### BACKGROUND

Third Generation Partnership Project (3GPP) networks provide for user equipments (UEs) to establish connections with core networks via base stations. The UEs can utilize network functions (NFs) of the core networks to provide services to the UEs. The UEs can utilize the non-access stratum (NAS) to communicate with the NFs. In legacy embodiments, the UEs would transmit NAS messages to a session management function (SMF) of the core networks that would forward the NAS messages to the proper NFs.

### BRIEF DESCRIPTION OF THE DRAWINGS

FIG. 1 illustrates a first portion of an example primary authentication procedure for fifth generation (5G) authentication and key agreement (AKA) in accordance with some embodiments.

FIG. 2 illustrates a second portion of the example primary authentication procedure of FIG. 1 in accordance with some embodiments.

FIG. 3 illustrates an example key hierarchy generation arrangement in a 5G system (5GS) in accordance with some embodiments.

FIG. 4 illustrates a first portion of an example key distribution and key derivation scheme for 5G for network nodes in accordance with some embodiments.

FIG. 5 illustrates a second portion of the example key distribution and key derivation scheme of FIG. 4 in accordance with some embodiments.

FIG. 6 illustrates a first portion of an example key distribution and key derivation scheme for 5G for the user equipment (UE) in accordance with some embodiments.

FIG. 7 illustrates a second portion of the example key distribution scheme of FIG. 6 in accordance with some embodiments.

FIG. 8 illustrates an example control plane protocol stack in accordance with some embodiments.

FIG. 9 illustrates an example non-access stratum (NAS) transport arrangement for session management (SM), short message service (SMS), UE Policy, and location services (LCS) in accordance with some embodiments.

FIG. 10 illustrates a first portion of an example stack for UE involved distributed NAS architecture in accordance with some embodiments.

FIG. 11 illustrates a second portion of the UE involved distributed NAS architecture of FIG. 10 in accordance with some embodiments.

FIG. 12 illustrates an example NAS security design for option 1 in accordance with some embodiments.

FIG. 13 illustrates an example NAS security design for option 2 in accordance with some embodiments.

FIG. 14 illustrates an example NAS security design for option 3 in accordance with some embodiments.

FIG. 15 illustrates an example NAS security design for option 4 in accordance with some embodiments.

FIG. 16 illustrates an example security design arrangement for option 1 in accordance with some embodiments.

FIG. 17 illustrates an example security design arrangement for option 2 in accordance with some embodiments.

FIG. 18 illustrates a first portion of an example call flow representation for option 1 in accordance with some embodiments.

FIG. 19 illustrates a second portion of the example call flow representation of FIG. 18 for option 1 in accordance with some embodiments.

FIG. 20 illustrates a first portion of an example call flow representation for option 2 in accordance with some embodiments.

FIG. 21 illustrates a second portion of the example call flow representation of FIG. 20 for option 2 in accordance with some embodiments.

FIG. 22 illustrates an example procedure for performing an authentication procedure for direct NAS connections in accordance with some embodiments.

FIG. 23 illustrates an example procedure for determining whether to provide access to a network function (NF) based at least in part on an authentication result in accordance with some embodiments.

FIG. 24 illustrates an example procedure for requesting establishment of a directed NAS connection with an NF in accordance with some embodiments.

FIG. 25 illustrates an example UE in accordance with some embodiments.

FIG. 26 illustrates an example next generation NodeB (gNB) in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “based at least in part on” as used herein may indicate that an item is based solely on another item and/or an item is based on another item and one or more additional items. For example, item 1 being determined based at least in part on item 2 may indicate that item 1 is determined based solely on item 2 and/or is determined based on item 2 and one or more other items in embodiments.

### Legacy Fifth Generation Authentication and Key Agreement Procedure

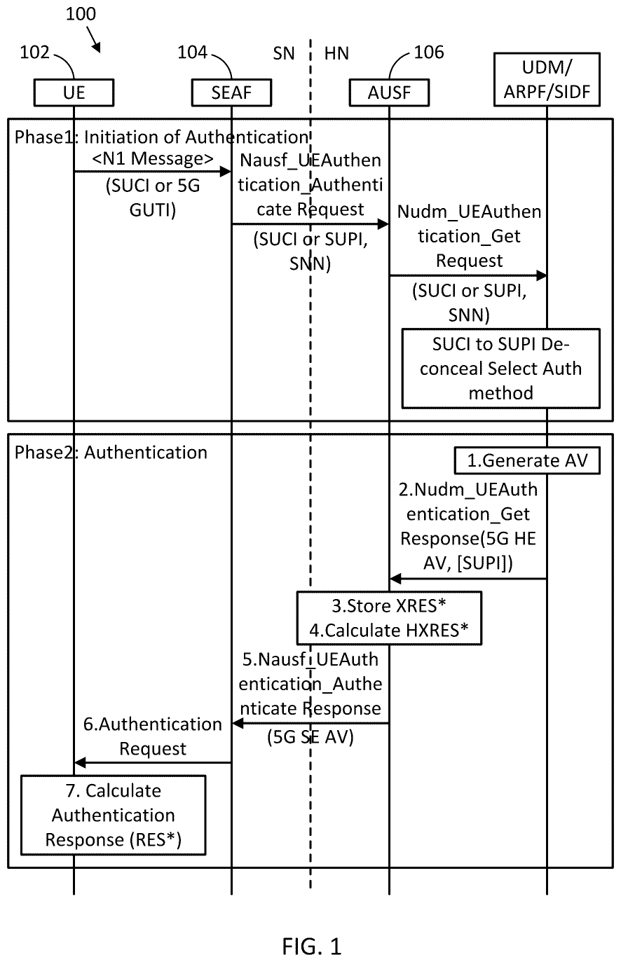

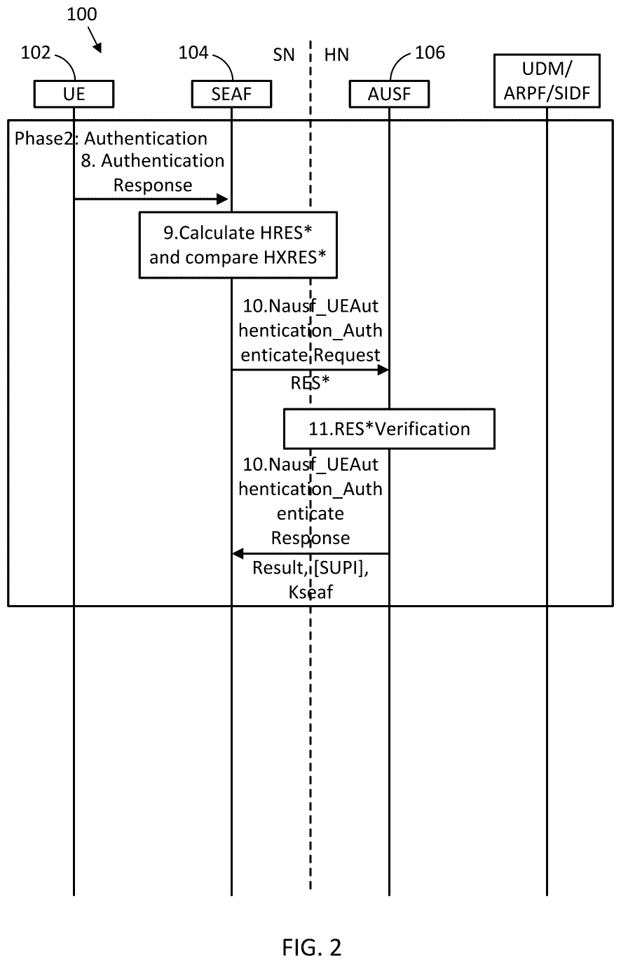

FIG. 1 illustrates a first portion of an example primary authentication procedure 100 for fifth generation (5G) authentication and key agreement (AKA) in accordance with some embodiments. FIG. 2 illustrates a second portion of the example primary authentication procedure 100 in accordance with some embodiments.

There are 2 Phases in 5G AKA/extensible authentication protocol-authentication and key agreement (EAP-AKA). The first phase is the initiation procedure (5G AKA/EAP-AKA). In the initiation procedures, a user equipment (UE) 102 sends identification to security anchor function (SEAF) 104 in visiting public land mobile network (VPLMN). The SEAF 104 sends the authentication request to authentication server function (AUSF) 106 in home public land mobile network (HPLMN).

The second phase is the authentication procedure (5G AKA). The authentication procedure includes authentication vector generation, containing the RAND, AUTN, XRES*, and KAUSF. The AUSF 106 derives the KSEAF (anchor key) from KAUSF and sends the Challenge message to the SEAF 104. At receipt of the RAND and AUTN, the universal subscriber identity module (USIM) computes a response RES and returns RES, CK, IK to the UE 102, ME computes RES* from RES and sends it back. The SEAF 104 computes HRES* from RES* and compares HRES* with HXRES*, if succeed, forwards RES* to the AUSF 106. The AUSF 106 compares the received RES* with the stored XRES*, if succeed, the authentication is successful and AUSF indicate to SEAF 104. As illustrated in the primary authentication procedure 100, AKA refers to Authentication and key agreement, AV refers to Authentication vector, SN refers to Serving network and HN refers to Home network.

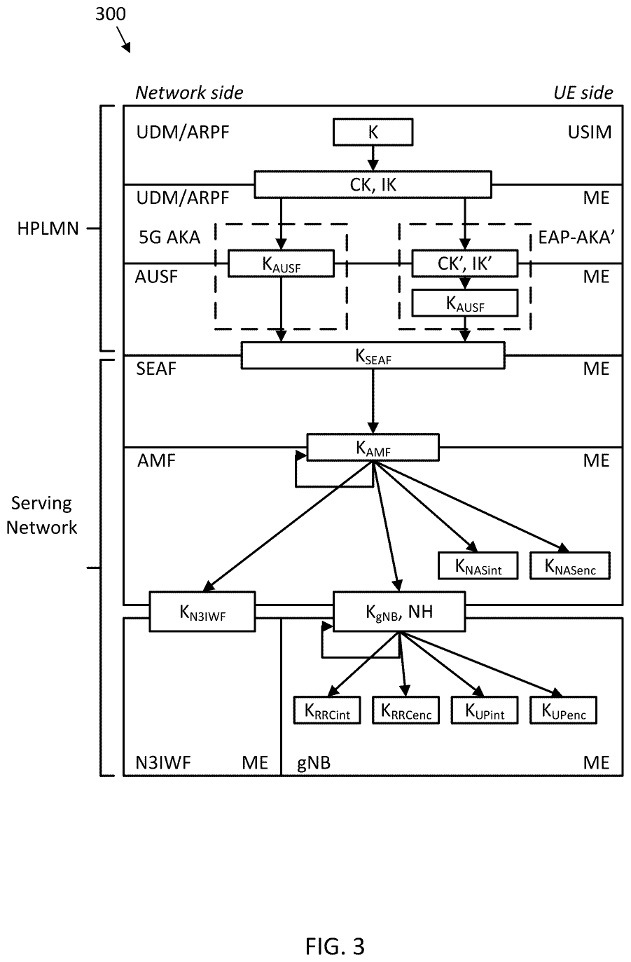

FIG. 3 illustrates an example key hierarchy generation arrangement 300 in a 5G system (5GS) in accordance with some embodiments. For example, the key hierarchy generation arrangement 300 illustrates an example of key generations in a legacy 5GS. This may be similar to that described in 3GPP TS 33.501 v18.4.0 (2024 Jan. 4).

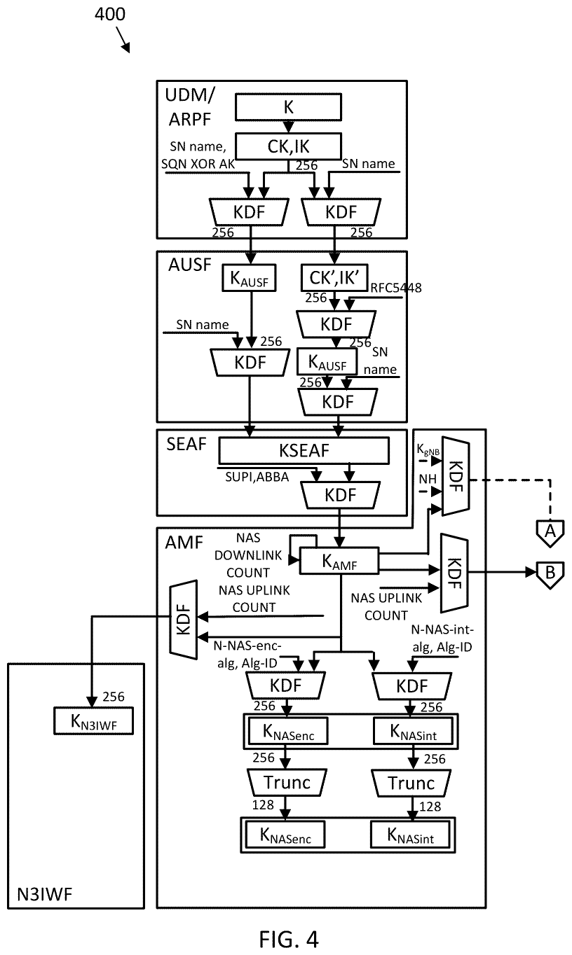

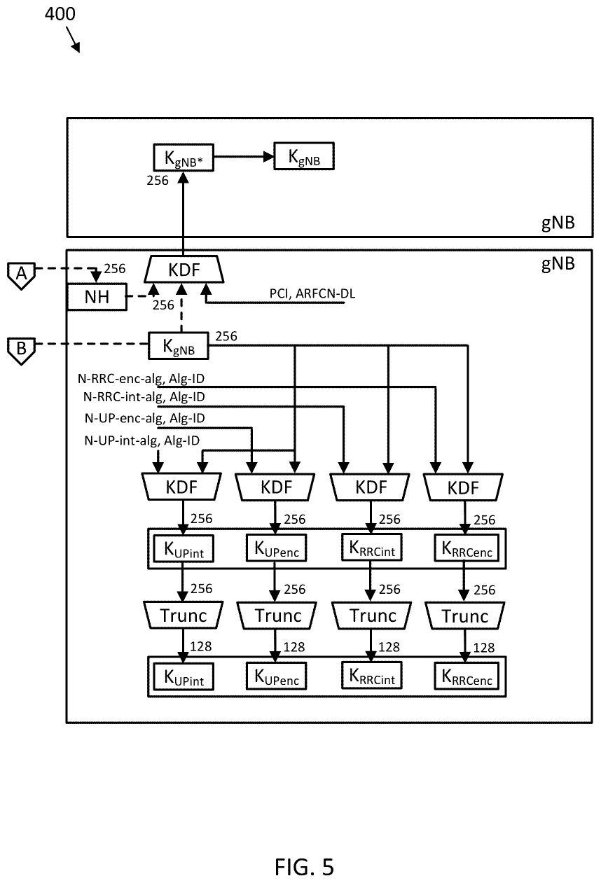

FIG. 4 illustrates a first portion of an example key distribution and key derivation scheme 400 for 5G for network nodes in accordance with some embodiments. FIG. 5 illustrates a second portion of the example key distribution and key derivation scheme 400 in accordance with some embodiments. For example, the key distribution and key derivation scheme 400 illustrates an example of how keys are distributed and derived in network nodes of a legacy 5GS. This may be similar to that described in 3GPP TS 33.501.

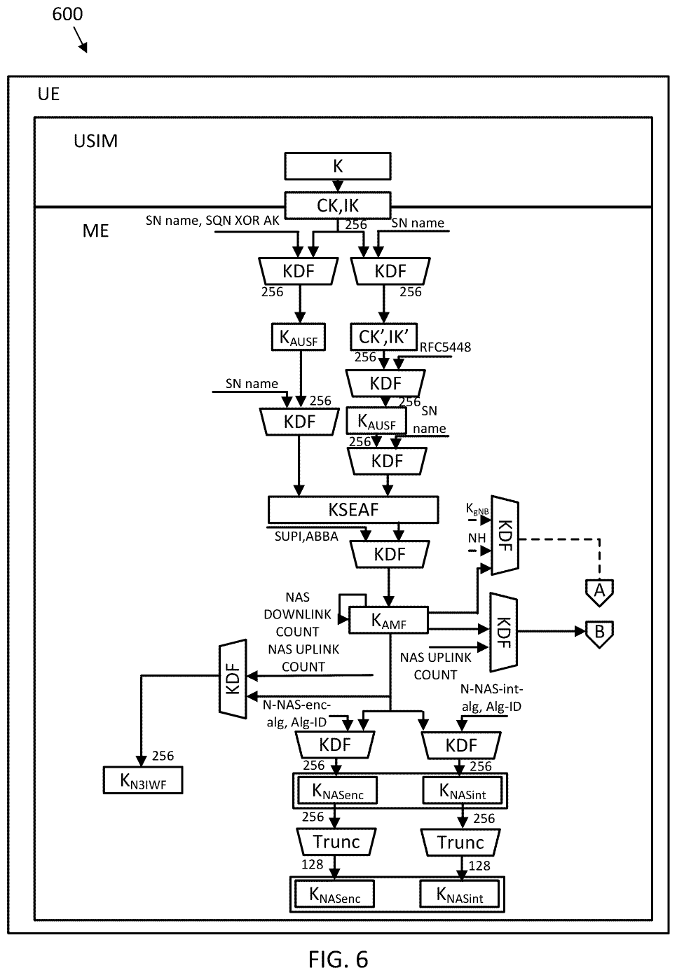

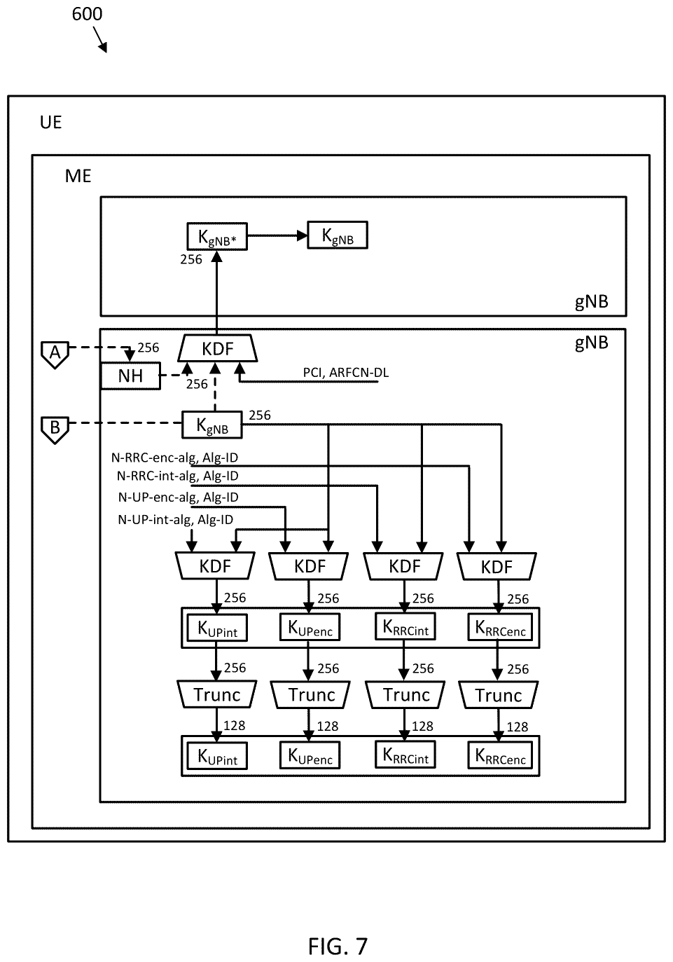

FIG. 6 illustrates a first portion of an example key distribution and key derivation scheme 600 for 5G for the UE in accordance with some embodiments. FIG. 7 illustrates a second portion of the example key derivation scheme 600 in accordance with some embodiments. For example, the key distribution and key derivation scheme 600 illustrates an example of how keys are distributed and derived in a UE of a legacy 5GS. This may be similar to that described in 3GPP TS 33.501.

Some embodiments describe a control plane protocol state for NAS signaling transportation.

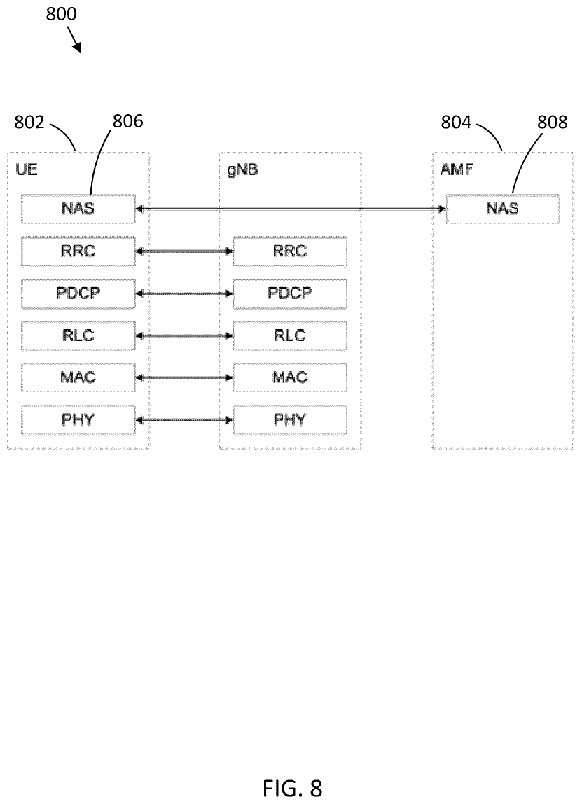

FIG. 8 illustrates an example control plane protocol stack 800 in accordance with some embodiments. The control plane protocol stack may be a legacy 5G control plane (CP) protocol stack. NAS messages may be promulgated between an NAS element 806 of a UE 802 and a NAS element 808 of an access and mobility management function (AMF) 804 of a network. The AMF 804 may be implemented by a core network of the network. The UE 802 may include circuitry and instructions that, when executed by the circuitry, can cause the UE 802 to support NAS layer communications. Further, the core network may include circuitry and instructions that, when executed by the circuitry, can cause the core network to implement the AMF 804 and support NAS layer communications.

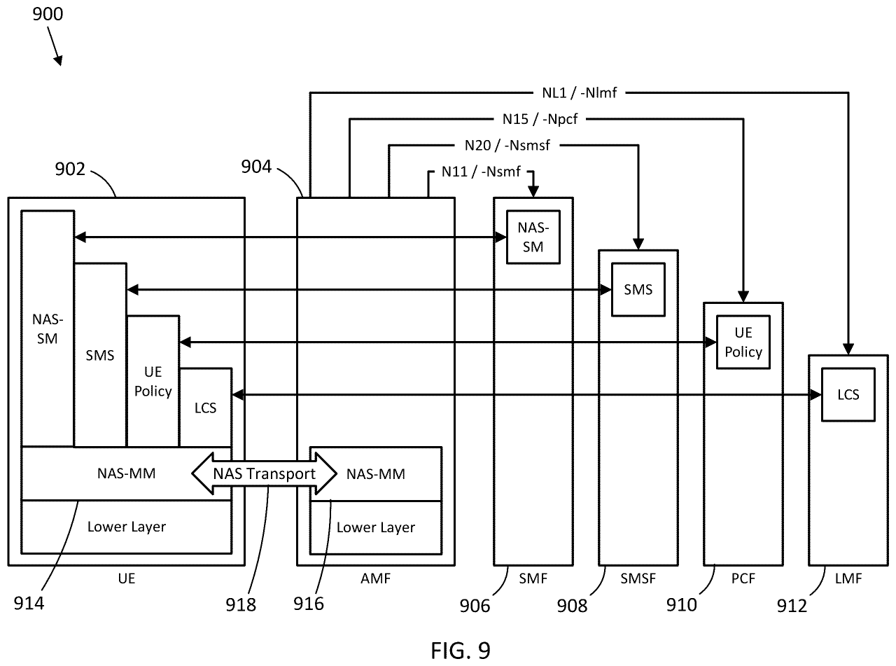

FIG. 9 illustrates an example NAS transport arrangement 900 for session management (SM), short message service (SMS), UE Policy, and location services (LCS) in accordance with some embodiments. The NAS transport arrangement 900 illustrates NAS operation for a legacy 5GS.

The NAS transport arrangement 900 illustrates NAS communications between a UE 902 and functions of a core network. The core network may include an AMF, a session management function (SMF) 906, a short message service function (SMSF) 908, a policy control function (PCF) 910, and/or a location management function (LMF) 912. The NAS communications are exchanged between an NAS-mobility management (MM) element 914 of the UE 902 and an NAS-MM element 916 of the AMF 904 via NAS transports 918. The AMF 904 then forwards the NAS communications to the corresponding NF for the NAS communications. All NAS communications are required to pass through the AMF 904 and cannot bypass the AMF 904.

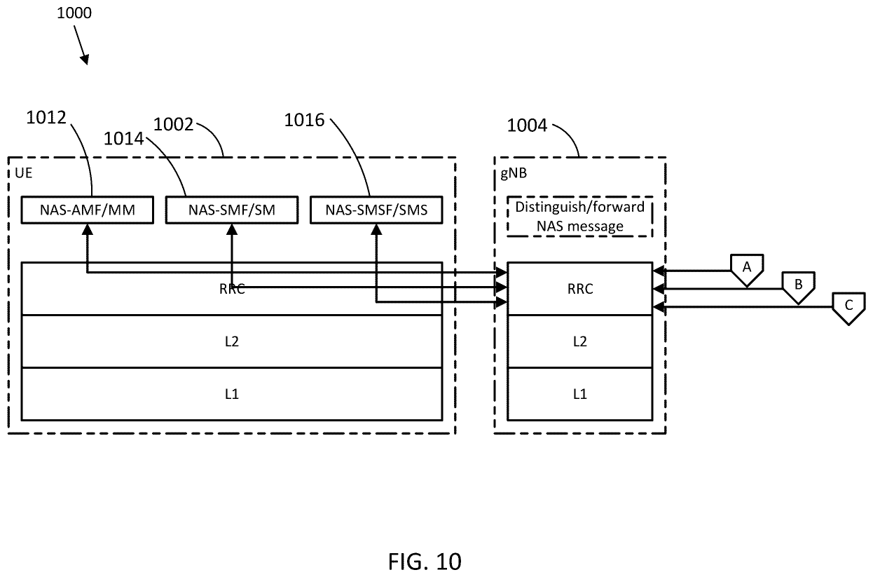

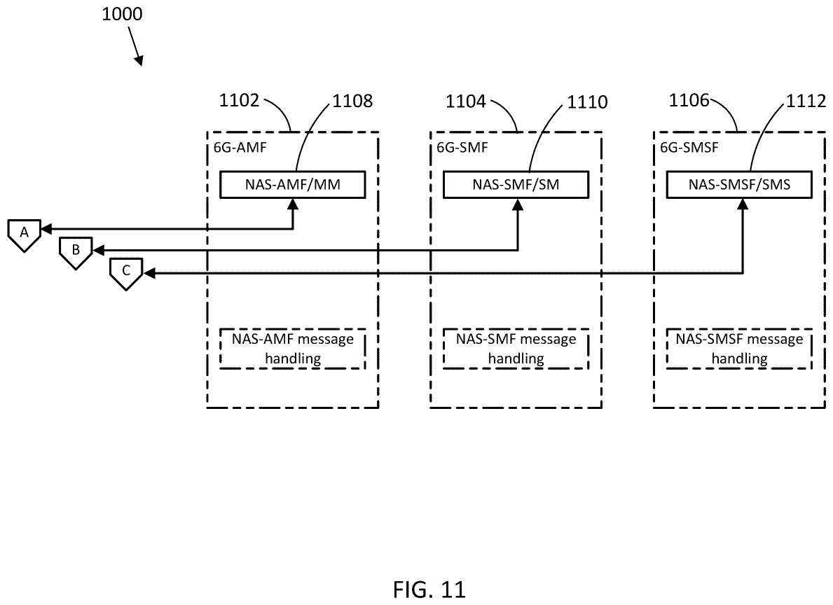

FIG. 10 illustrates a first portion of an example stack for UE involved distributed NAS architecture 1000 in accordance with some embodiments. FIG. 11 illustrates a second portion of the UE involved distributed NAS architecture 1000 in accordance with some embodiments. The stack may be a proposed stack for UE involved distributed NAS architecture in sixth generation (6G). NAS-AMF and NAS-SMF in the architecture are just for example. In particular, the NAS architecture 1000 is illustrated with NAS-AMF, NAS-SMF, and NAS-SMSF as example of the NAS architecture 1000 in accordance with some embodiments. The NAS architecture 1000 may includes NAS-AMF, NAS-SMF, NAS-SMSF, and/or one or more other NFs in other embodiments.

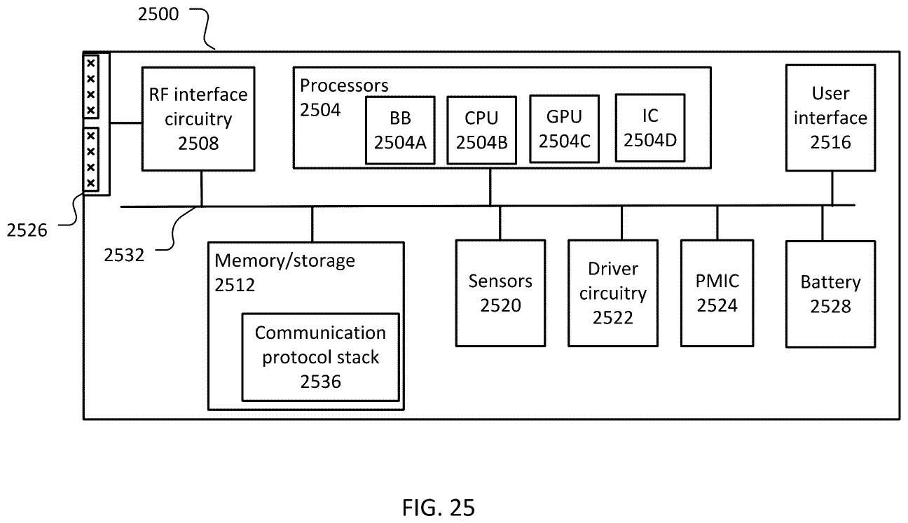

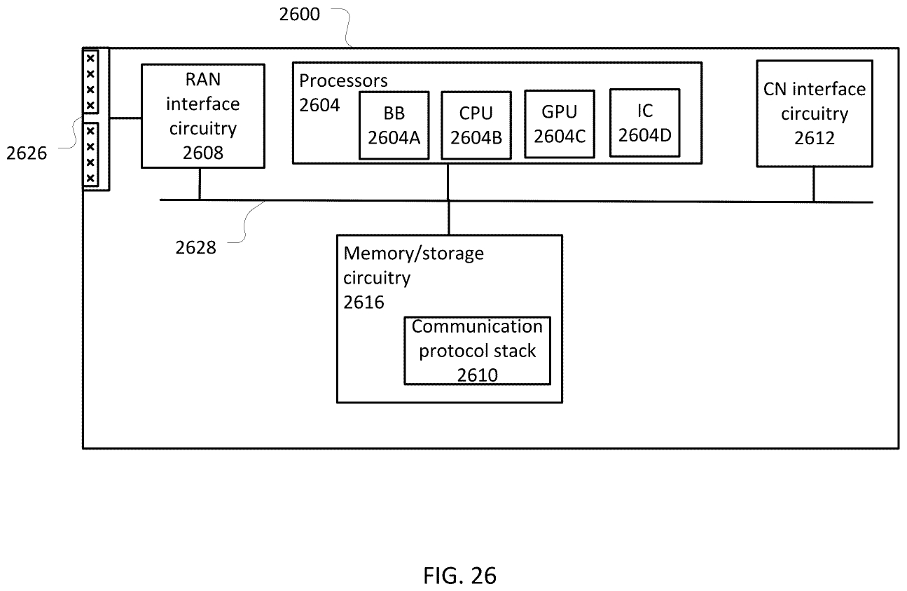

The NAS architecture 1000 may include a UE 1002, a base station 1004, and a core network. The core network may implement one or more NFs. In the illustrated embodiment, the core network implements an AMF 1102, an SMF 1104, and an SMSF 1106. The UE 1002 may include one or more of the features of the UE 2500 (FIG. 25). The base station 1004 may include one or more of the features of the next generation NodeB (gNB) 2600 (FIG. 26). The UE 1002 may establish a connection with the base station 1004 that can allow the UE 1002 to communicate with the NFs of the core network via the base station 1004.

The UE 1002 may implement one or more NAS elements that can support NAS communication with the NFs of the network via the base station 1004. For example, the UE 1002 implements a NAS-AMF/MM element 1012, a NAS-SMF/session management (SM) element 1014, and a NAS-SMSF/SMS element 1016 in the illustrated embodiment. The UE 1002 may include circuitry and instructions that, when executed by the circuitry, cause the UE 1002 to implement the one or more NAS elements.

The NFs of the core network may implement one or more NAS elements that can support NAS communication with the UE 1002 via the base station 1004. For example, the AMF 1102 implements an NAS-AMF/MM element 1108, the SMF 110 implements an NAS-SMF/SM element 1110, and the SMSF 1106 implements an NAS-SMSF/SMS element 1112 in the illustrated embodiment.

NAS messages exchanged between the UE 1002 and the NFs of the core network in the NAS architecture 1000 may be communicated directly between the corresponding NAS elements. For example, the NAS messages from the NAS-AMF/MM element 1012 of the UE 1002 may be provided directly to the NAS-AMF/MM element 1108, the NAS messages from the NAS-SMF/SM element 1014 of the UE 1002 may be provided directly to the NAS-SMF/SM element 1110, and the NAS messages from the NAS-SMSF/SMS element 1016 of the UE 1002 may be provided directly to the NAS-SMSF/SMS element 1112. Whereas the legacy approaches had the NAS messages between the SMF and the UE, and between the SMSF and the UE passing through the AMF, the NAS messages between the SMF 1104 and the UE 1002, and between the SMSF 1106 and the UE 1002 may bypass the AMF 1102 and be provided directly to the SMF 1104 and the SMSF 1106. As used herein, connections that allow NAS messages to be exchanged between the corresponding NAS elements of a UE and a core network without being passed through a different NF of the core network may be referred to as direct connections or direct NAS connections. For example, a connection that allows NAS messages to be exchanged between the NAS-SMF/SM element 1014 and the NAS-SMF/SM element 1110 without the NAS messages passing through the AMF 1102 may be referred to as a direct connection, a direct NAS connection, and/or a NAS-X connection between the UE 1002 and the SMF 1104.

Having direct NAS connections between the UE 1002 and the corresponding NFs of the core network could provide for improved operation as compared to legacy approaches that required all NAS messages to pass through an AMF. For example, the AMF in the legacy approaches would be required to at least partially process every NAS message being communicated with the core network to determine where the NAS message needed to be forwarded. As the number of NAS messages being exchanged with core networks have increased, the processing required by the AMF of all the NAS messages in the legacy approaches has become an issue in the operation speed of the systems. Direct NAS connections allow the processing of incoming NAS messages to be spread between the NFs of the core network which can improve the operation speed of the systems as compared to the legacy approaches.

In legacy embodiments where the NAS messages were passed through AMFs to other NFs within the core network, a single authentication procedure could be performed for the UE to determine whether the UE is authorized to access the AMF. Since all the NAS messages with the core network passed through the AMF, the single authentication procedure provided adequate protection against bad actors that could transmit NAS messages. However, the direct NAS connections with other NFs of the core network presents a challenge of how to provide authentication for NAS messages for the other NFs. The legacy approach of authentication for only the AMF does not address this challenge.

Some embodiments describe a security design for distributed NAS architecture.

AKA is performed separately and independently in 5G, assuming UE is authenticated in an independent procedure. NAS security is the subsequent procedure after the successful AKA. This central entity also covers Key Management Function (key derivation, key update, key storage and deletion).

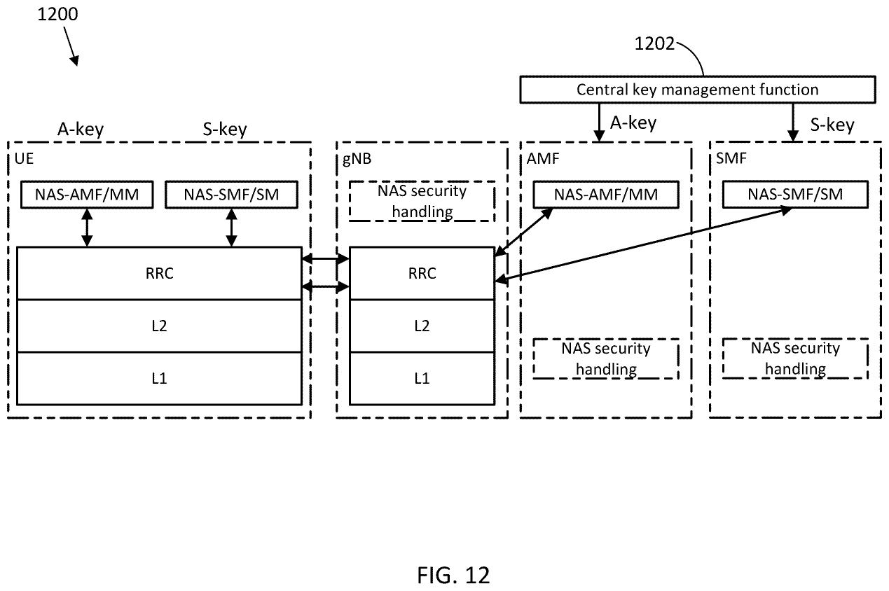

Options for NAS security design on the NAS message for NAS-X connection are presented herein. For a first option (Option 1) a New Central Key management function may be included in the core network (CN) (preferred from standardization perspective). FIG. 12 illustrates an example NAS security design 1200 for option 1 in accordance with some embodiments. The NAS security design 1200 may include a central key management function 1202 in the CN. In a first approach of the first option (Option 1.1), different keys may be utilized in AMF and SMF. In a second approach of the first option (Option 1.2), the same key may be utilized in AMF and SMF.

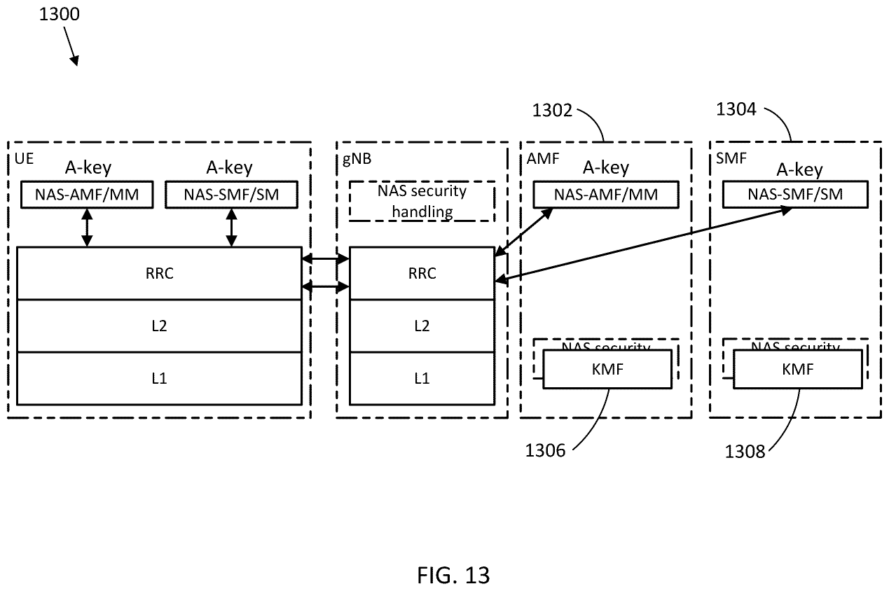

For a second option (Option 2), a Key Management Function may be included in in every network element (NE). FIG. 13 illustrates an example NAS security design 1300 for option 2 in accordance with some embodiments. In the illustrated embodiment, the NAS security design 1300 includes an AMF 1302 and an SMF 1304. The AMF 1302 includes a first key management function 1306 and the SMF 1304 includes a second key management function 1308.

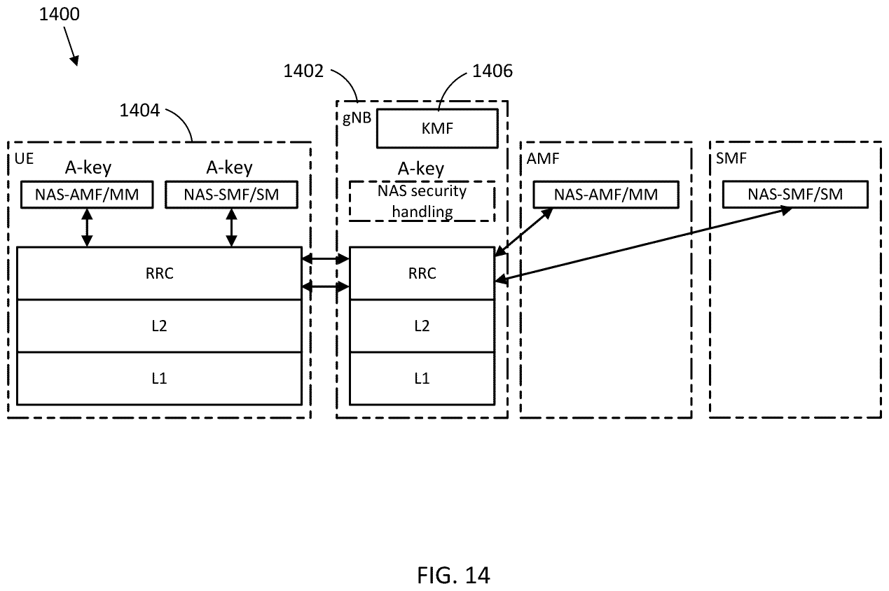

For a third option (Option 3), assume gNB (representing 6G radio access network (RAN)) handle the NAS key. For example, a base station with which a UE connects may handle a NAS key for NAS communications. FIG. 14 illustrates an example NAS security design 1400 for option 3 in accordance with some embodiments. NAS security security operation is implemented in RAN. For example, the NAS security design 1400 may include a base station 1402 with which a UE 1404 may establish a connection. The base station 1402 may include a key management function 1406 to handle the NAS key. The NAS security part can be carried in RRC message.

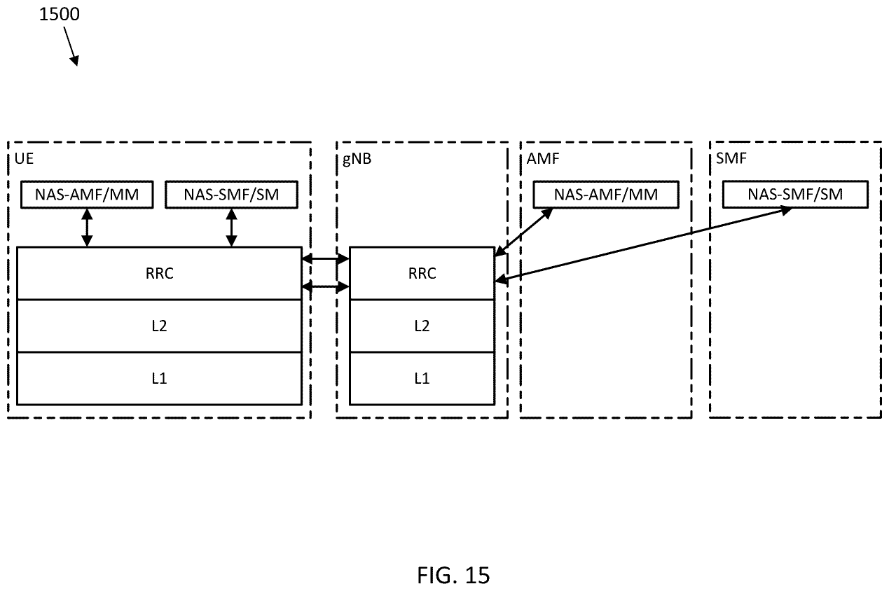

For a fourth option (Option 4), there may be no NAS security. FIG. 15 illustrates an example NAS security design 1500 for option 4 in accordance with some embodiments. The NAS security design 1500 may not include any key management functions and may not utilize keys to provide NAS security.

Motivation: In one UE connection, multiple NAS-X connections can be established between UE and different NFs for different purposes. For each NAS-X connection, RAN node can distinguish the NAS-X connection and forward the NAS message to the corresponding NFs. For example, a base station with which a UE has established a connection may receive NAS messages and determine to which NF each of the NAS messages is to be forwarded. The base station may then forward the NAS messages to the determined corresponding NF. Therefore, with distributed NAS architecture, 5G authentication procedure is not applied any more.

Summary: In distributed NAS architecture, the authentication procedure may be leveraged for every NAS connection. For example, every NAS connection may be based on a successful authentication procedure. There are 2 different options for the authentication procedures. For a first option (Option 1), one single authentication may be performed by a central entity, the authentication result can be used for every NAS end point. The authentication procedure may be performed once. For a second option, (Option 2), different authentication procedures may be performed for different NAS connections. The authentication procedure may be performed for every NAS connection.

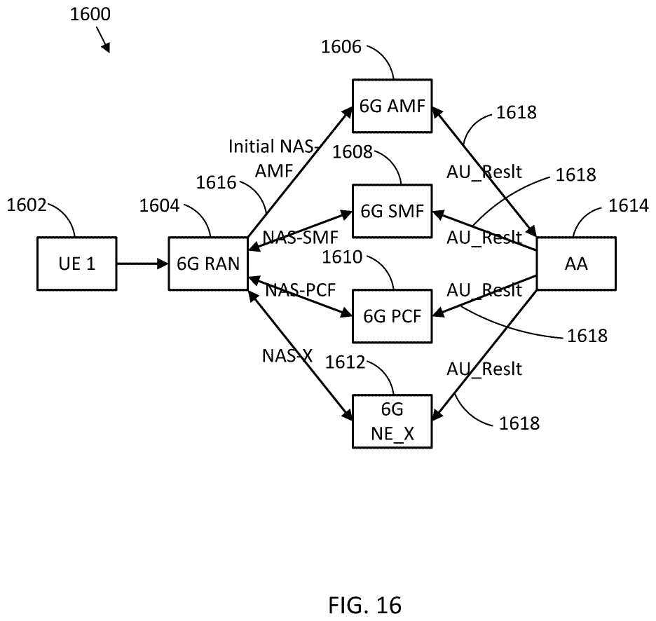

FIG. 16 illustrates an example security design arrangement 1600 for option 1 in accordance with some embodiments. The security design arrangement 1600 illustrates an example authentication that may be implemented for a distributed NAS architecture where direct NAS connections may be established between UEs and NFs of core networks.

The security design arrangement 1600 may include a UE 1602. The UE 1602 may include one or more of the features of the UE 2500 (FIG. 25). The UE 1602 may be configured to establish direct NAS connections with NFs of a core network. The UE 1602 may establish a connection with a base station and utilize the base station for communicating with the core network.

The security design arrangement 1600 may include a base station 1604. The base station 1604 may include one or more features of the gNB 2600 (FIG. 26). The base station 1604 may be coupled to a core network. One or more UEs, including the UE 1602, may establish a connection with the base station 1604 to connect to the core network. UEs connected to the base station 1604 may access services of the core network via the base station. In the illustrated embodiment, the UE 1602 has established a connection with the base station 1604.

The security design arrangement 1600 may include a core network. The core network may implement one or more NFs. In the illustrated embodiment, the core network implements an AMF 1606, an SMF 1608, a PCF 1610 and one or more other NFs 1612, as illustrated in the security design arrangement 1600. One or more base stations may be coupled to the NFs of the core network and can communicate with the NFs. In the illustrated embodiment, the base station 1604 is coupled to the AMF 1606, the SMF 1608, the PCF 1610, and the one or more other NFs 1612.

The security design arrangement 1600 may include an authentication anchor (AA) 1614. In some embodiments, the AA 1614 may include an AUSF. The AA 1614 may be coupled to one or more NFs of the core network. In some embodiments, the AA 1614 may be coupled to all NFs of a core network. In the illustrated embodiment, the AA 1614 is coupled to the AMF 1606, the SMF 1608, the PCF 1610, and the one or more other NFs 1612. The AA 1614 may perform authentication for the NFs to which it is coupled. For example, the AA 1614 may perform authentication procedures for the AMF 1606, the SMF 1608, the PCF 1610, and the one or more other NFs.

For the first option (Option 1), AA performs one authentication after receiving NAS-AMF request. The UE 1602 may generate and transmit an initial NAS connection request to the base station 1604. The base station 1604 may identify the initial NAS connection request received from the UE 1602. The base station 1604 may generate an initial NAS-AMF request 1616 based on the initial NAS connection request from the UE 1602. The base station 1604 may transmit the initial NAS-AMF request 1616 to the AMF 1606. The AMF 1606 may provide the initial NAS-AMF request 1616 to the AA 1614. The AA 1614 may perform an authentication procedure for the UE 1602 based on receipt of the initial NAS-AMF request 1616 to authenticate the UE 1602 and/or determine if the UE 1602 is authorized to access the NFs of the core network.

The AA generate one authentication result Au_Reslt: Authentication result for NAS-AMF (initial NAS). For example, the AA 1614 may generate an authentication result 1618 as part of the authentication procedure for the UE 1602 performed based on the received initial NAS-AMF request 1616. The authentication result 1618 may indicate whether the UE 1602 has been authenticated and/or whether the UE 1602 is authorized to access the NFs.

The AA shares this one AU_Reslt to every other network elements (NEs). For example, the AA 1614 may share the authentication result 1618 generated as part of the authentication procedure with the NFs. In the illustrated embodiment, the AA 1614 shares the authentication result 1618 with the AMF 1606, the SMF 1608, the PCF 1610, and the one or more other NFs 1612.

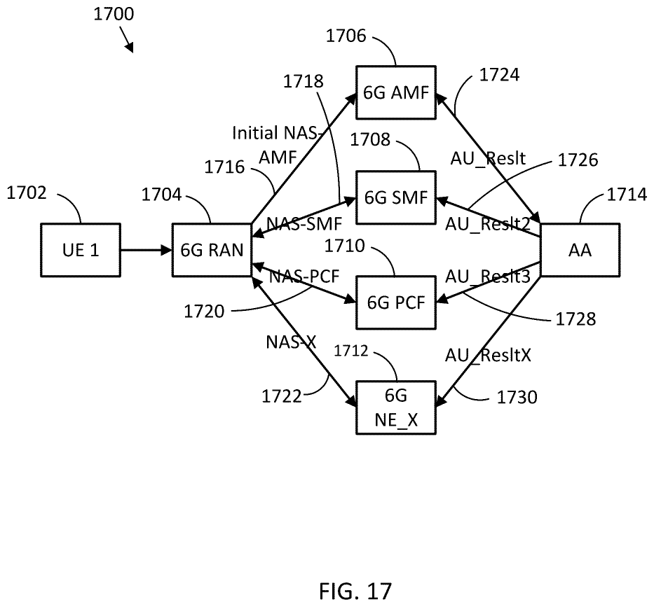

FIG. 17 illustrates an example security design arrangement 1700 for option 2 in accordance with some embodiments. The security design arrangement 1700 illustrates an example authentication that may be implemented for a distributed NAS architecture where direct NAS connections may be established between UEs and NFs of core networks.

The security design arrangement 1700 may include a UE 1702. The UE 1702 may include one or more of the features of the UE 2500 (FIG. 25). The UE 1702 may be configured to establish direct NAS connections with NFs of a core network. The UE 1702 may establish a connection with a base station and utilize the base station for communicating with the core network.

The security design arrangement 1700 may include a base station 1704. The base station 1704 may include one or more features of the gNB 2600 (FIG. 26). The base station 1704 may be coupled to a core network. One or more UEs, including the UE 1702, may establish a connection with the base station 1704 to connect to the core network. UEs connected to the base station 1704 may access services of the core network via the base station. In the illustrated embodiment, the UE 1702 has established a connection with the base station 1704.

The security design arrangement 1700 may include a core network. The core network may implement one or more NFs. In the illustrated embodiment, the core network implements an AMF 1706, an SMF 1708, a PCF 1710 and one or more other NFs 1712, as illustrated in the security design arrangement 1700. One or more base stations may be coupled to the NFs of the core network and can communicate with the NFs. In the illustrated embodiment, the base station 1704 is coupled to the AMF 1706, the SMF 1708, the PCF 1710, and the one or more other NFs 1712.

The security design arrangement 1700 may include an authentication anchor (AA) 1714. In some embodiments, the AA 1714 may include an AUSF. The AA 1714 may be coupled to one or more NFs of the core network. In some embodiments, the AA 1714 may be coupled to all NFs of a core network. In the illustrated embodiment, the AA 1714 is coupled to the AMF 1706, the SMF 1708, the PCF 1710, and the one or more other NFs 1712. The AA 1714 may perform authentication for the NFs to which it is coupled. For example, the AA 1714 may perform authentication procedures for the AMF 1706, the SMF 1708, the PCF 1710, and the one or more other NFs.

For the second option (Option 2), AA performs more than one authentication after receiving NAS-AMF request. For example, the AA 1714 may perform an authentication procedure for each of the NFs. The AA 1714 may perform an authentication procedure for an NF based on receipt of a NAS access request received from the NF to authenticate the UE 1702 and/or determine whether the UE 1702 is authorized to access the NF.

In the illustrated embodiment, the UE 1702 may generate and transmit an initial NAS-AMF connection request to the base station 1704. The base station 1704 may identify the initial NAS-AMF connection request received from the UE 1702. The base station 1704 may generate an initial NAS-AMF request 1716 based on the initial NAS connection request from the UE 1702. The base station 1704 may transmit the initial NAS-AMF request 1716 to the AMF 1706. The AMF 1706 may provide the initial NAS-AMF request 1716 to the AA 1714. The AA 1714 may perform an authentication procedure for the UE 1702 based on receipt of the initial NAS-AMF request 1716 to authenticate the UE 1702 and/or determine if the UE 1702 is authorized to access the AMF 1706.

Further, the UE 1702 may generate and transmit an NAS-SMF connection request to the base station 1704. The base station 1704 may identify the NAS-SMF connection request received from the UE 1702. The base station 1704 may generate an NAS-SMF request 1718 based on the NAS-SMF connection request from the UE 1702. The base station 1704 may transmit the NAS-SMF request 1718 to the SMF 1708. The SMF 1708 may provide the NAS-SMF request 1718 to the AA 1714. The AA 1714 may perform an authentication procedure for the UE 1702 based on receipt of the NAS-SMF request 1718 to authenticate the UE 1702 and/or determine if the UE 1702 is authorized to access the SMF 1708.

The UE 1702 may generate and transmit an NAS-PCF connection request to the base station 1704. The base station 1704 may identify the NAS-PCF connection request received from the UE 1702. The base station 1704 may generate an NAS-PCF request 1720 based on the NAS-PCF connection request from the UE 1702. The base station 1704 may transmit the NAS-PCF request 1720 to the PCF 1710. The PCF 1710 may provide the NAS-PCF request 1720 to the AA 1714. The AA 1714 may perform an authentication procedure for the UE 1702 based on receipt of the NAS-PCF request 1720 to authenticate the UE 1702 and/or determine if the UE 1702 is authorized to access the PCF 1710.

The UE 1702 may generate and transmit an NAS-X connection request to the base station 1704. The base station 1704 may identify the NAS-X connection request received from the UE 1702. The base station 1704 may generate an NAS-X request 1722 based on the NAS-X connection request from the UE 1702. The base station 1704 may transmit the NAS-X request 1722 to the one or more other NFs 1712. The one or more other NFs 1712 may provide the NAS-X request 1722 to the AA 1714. The AA 1714 may perform an authentication procedure for the UE 1702 based on receipt of the NAS-X request 1722 to authenticate the UE 1702 and/or determine if the UE 1702 is authorized to access the one or more other NFs 1712.

The AA may generate more than one authentication result. For example, the AA 1714 may generate one or more authentication results, where each of the authentication results correspond to one of the NFs requesting authentication. The AA 1714 may generate an authentication result (Au_Reslt) 1724 as part of the authentication procedure for the UE 1702 performed based on the received initial NAS-AMF request 1716. The authentication result 1724 may indicate whether the UE 1702 has been authenticated and/or whether the UE 1702 is authorized to access the AMF 1706.

Au_Reslt2: Authentication result for NAS-SMF. For example, the AA 1714 may generate a second authentication result (Au_Reslt2) 1726 as part of the authentication procedure for the UE 1702 performed based on the received NAS-SMF request 1718. The second authentication result 1726 may indicate whether the UE 1702 has been authenticated and/or whether the UE 1702 is authorized to access the SMF 1708.

Au_Reslt3: Authentication result for NAS-PCF. For example, the AA 1714 may generate a third authentication result (Au_Reslt3) 1728 as part of the authentication procedure for the UE 1702 performed based on the received NAS-PCF request 1720. The third authentication result 1728 may indicate whether the UE 1702 has been authenticated and/or whether the UE 1702 is authorized to access the PCF 1710.

Au_Resltx: Authentication result for NAS-NE_X. 3. For example, the AA 1714 may generate a fourth authentication result (Au_ResltX) 1730 as part of the authentication procedure for the UE 1702 performed based on the received NAS-X request 1722. The fourth authentication result 1730 may indicate whether the UE 1702 has been authenticated and/or whether the UE 1702 is authorized to access the one or more other NFs 1712. The authentication results for different NAS connections can not be shared. In particular, the authentication results can only be shared with the corresponding NF.

While the security design arrangement 1600 and the security design arrangement 1700 describe a NAS-AMF request as the initial request for NAS connections, it should be understood that the order of NAS connection requests may differ in other instances. Further, it should be understood that some embodiments may utilize a combination of option 1 and option 2 where two or more of the NFs may share an authorization result while the other NFs may have their own authentication results that cannot be shared. In some embodiments, at least a portion of the NFs may be assigned to groups where an authentication result for a group may be shared between the NFs within the group and cannot be shared with NFs in other groups.

Some embodiments describe one authentication for all NAS connections, which may be referred to as option 1.

For option 1, one single authentication may be performed by a central entity (such as the AA 1614 and/or the AA 1714), the authentication result can be used for every NAS end point. The authentication procedure may be performed once. The central entity could be central key management function (CKMF), it could also be a network entity in 6G (e.g., 6G AMF). The central entity may be the Authentication Anchor. The authentication procedure may take place the first time UE is accessing to the network.

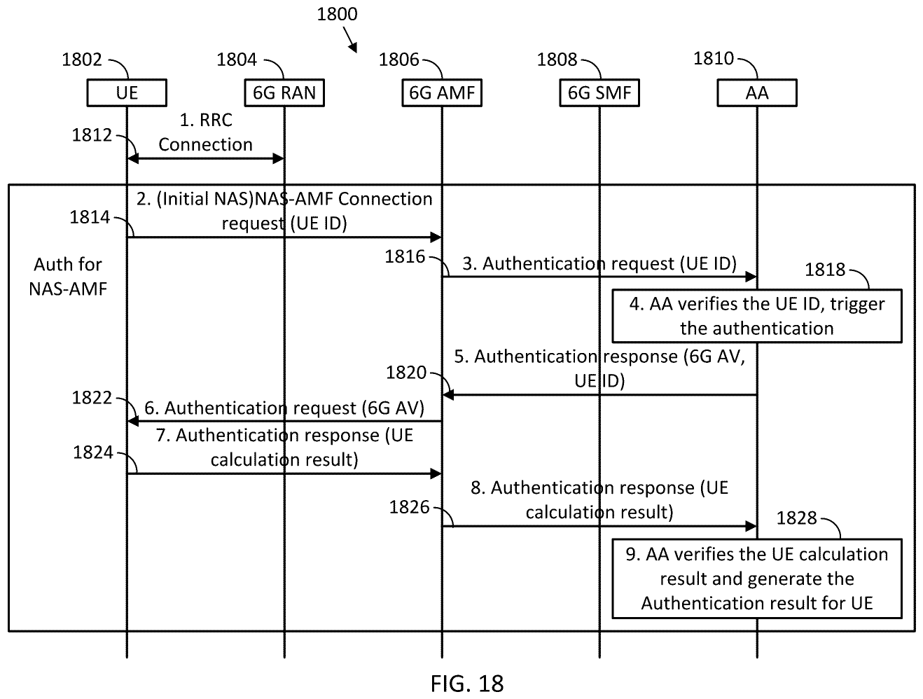

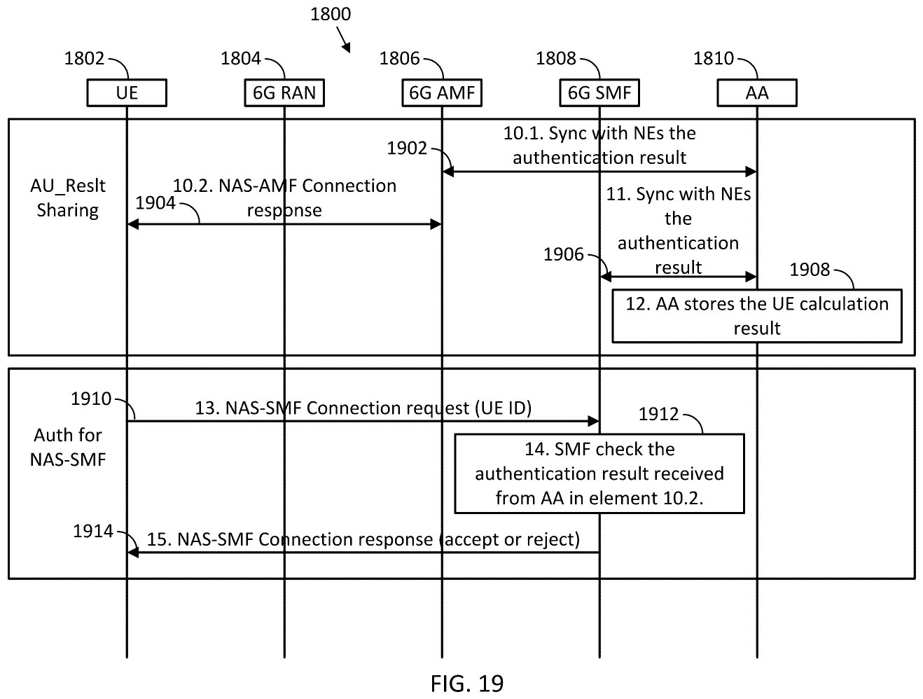

FIG. 18 illustrates a first portion of an example call flow representation 1800 for option 1 in accordance with some embodiments. FIG. 19 illustrates a second portion of the example call flow representation 1800 for option 1 in accordance with some embodiments. The call flow representation 1800 may be performed by a portion of system, such as the system represented by the security design arrangement 1600 (FIG. 16). In some embodiments, the call flow representation 1800 may be for a non-roaming call flow.

The call flow representation 1800 may include a UE 1802. The UE 1802 may include one or more of the features of the UE 2500 (FIG. 25). The call flow representation 1800 may further include a base station 1804. The base station 1804 may include one or more of the features of the gNB 2600 (FIG. 26). The UE 1802 may establish a connection with the base station 1804.

The call flow representation 1800 may include one or more NFs of a core network. In the illustrated embodiment, the call flow representation 1800 includes an AMF 1806 and an SMF 1808 of a core network. The base station 1804 may be coupled to the core network and may be coupled to one or more of the NFs of the core network. In the illustrated embodiment, the base station 1804 is connected to the AMF 1806 and the SMF 1808. The base station 1804 may facilitate connected UEs (including the UE 1802) to establish connections and/or utilize services provided by the NFs (including the AMF 1806 and the SMF 1808).

The call flow representation 1800 may include an AA 1810. The AA 1810 may include one or more of the features of the AA 1614 (FIG. 16) and/or the AA 1714 (FIG. 17). The AA 1810 may provide authentication services for NFs coupled to the AA 1810. The AMF 1806 and the SMF 1808 may be coupled to the AA 1810 in the illustrated embodiment. The AA 1810 may provide authentication services for the AMF 1806 and the SMF 1808. The AA 1810 may be configured in accordance with option 1 where a single authentication procedure may be performed to generate an authentication result that can be shared with multiple NFs of the core network.

Elements of an authentication procedure in accordance with option 1 are illustrated in the call flow representation 1800. Elements 1-2, UE may initially connect to the network. For example, the UE 1802 may perform a radio resource control (RRC) connection procedure 1812 to establish a connection with the base station 1804.

It is assumed that the first network entity UE connects to is 6G AMF. For example, the UE 1802 may generate and transmit an NAS-AMF connection request 1814 to the AMF 1806 via the base station 1804. The NAS-AMF connection request 1814 may be an initial NF connection request. It could be other network entities, depending on future 6G network registration procedure. For example, the initial NF connection request can be transmitted to a different NF in other instances. 6G AMF is shown here as an example. UE may include its ID in the request. For example, the NAS-AMF connection request 1814 may include a UE identifier (ID) corresponding to the UE 1802. The ID could be a subscription concealed identifier (SUCI) or a 6G global unique temporary identifier (GUTI). The UE ID may contain sufficient information on the AA address/home public land mobile network (HPLMN) information, so that AMF could find the correct AA for authentication. For example, the AMF 1806 may determine a proper AA for authentication of the UE 1802 based on the UE ID included in the NAS-AMF connection request 1814.

Element 3, AMF may send the authentication request to AA. For example, the AMF 1806 may determine that the AA 1810 is the proper AA for authentication of the UE 1802 based on the UE ID included in the NAS-AMF connection request 1814. The AMF 1806 may generate and transmit an authentication request 1816 to the AA 1810. The authentication request 1816 may include the UE ID corresponding to the UE 1802.

Element 4, AA verifies the UE ID. For example, the AA 1810 may verify that it can perform authentication of the UE 1802 based on the UE ID included in the authentication request in 1818. If successful, AA triggers the authentication procedure. For example, the AA 1810 may initiate an authentication procedure for the UE 1802 based on the AA 1810 determining that it can perform authentication of the UE 1802.

Elements 5-9, 6G AKA. AA sends the authentication vector (AV) to the UE, UE calculates the result and sent it back to AA. For example, the AA 1810 may generate and transmit an authentication response 1820 to AMF 1806 as part of the authentication procedure. The authentication response 1820 may include an AV and the UE ID.

The AMF 1806 may identify the authentication response 1820 received from the AA 1810. The AMF 1806 may generate an authentication request 1822 based on receiving the authentication response 1820, where the authentication request 1822 may include the AV. The AMF 1806 may determine a UE to which the authentication request 1822 is to be transmitted based on the UE ID included in the authentication response 1820, where the AMF 1806 can determine that the authentication request 1822 is to be transmitted to the UE 1802 in the illustrated embodiment. The AMF 1806 may transmit the authentication request 1822 to the UE 1802.

The UE 1802 may identify the authentication request 1822 received from the AMF 1806. Further, the UE 1802 may identify the AV from the authentication request 1822. The UE 1802 may perform a calculation with the AV to produce a UE calculation result. The UE 1802 may generate and transmit an authentication response 1824 to the AMF 1806 based on the reception of the authentication request 1822. The authentication response 1824 can include the UE calculation result produced by the calculation with the AV.

The AMF 1806 may identify the authentication response 1824 received from the UE 1802. The AMF 1806 may generate and/or transmit an authentication response 1826 to the AA 1810. The authentication response 1826 may include the UE calculation result received in the authentication response 1824.

The AA 1810 may identify the authentication response 1826 received from the AMF 1806. The AA 1810 may verify the UE calculation result and generate an authentication result for the UE 1802 in 1828. For example, the AA 1810 may authenticate the UE 1802 and/or determine whether the UE 1802 is authorized to access the AMF 1806 and/or the SMF 1808 based on the UE calculation result. The AA 1810 may generate an authentication result for the UE 1802 that indicates whether the UE 1802 has been authenticated and/or whether the UE 1802 is authorized to access the AMF 1806, the SMF 1808, and/or other NFs of the core network.

Element 10.1-10.2, AA synchronizes the authentication result with 6G AMF, then UE and AMF set up the NAS AMS connection. Element 11, AA synchronizes the authentication result with 6G SMF, also other network entities. For example, the AA 1810 may share the authentication result produced in 1828 with NFs of the core network. The AA 1810 may share the authentication result with the AMF 1806, the SMF 1808, and/or other NEs of the core network.

The AA 1810 may perform a first synchronization procedure 1902 with the AMF 1806 to synchronize the AMF 1806. The first synchronization procedure 1902 may include the authentication result produced in 1828. The AMF 1806 may determine whether the UE 1802 has been authenticated and/or is authorized to access the AMF 1806. The AMF 1806 may generate an NAS-AMF connection response 1904 that indicates whether the UE 1802 is provided access to the AMF 1806. The AMF 1806 may transmit the NAS-AMF connection response 1904 to the UE 1802. The UE 1802 may identify the NAS-AMF connection response 1904 and may determine whether the UE 1802 can access the AMF 1806 based on the NAS-AMF connection response 1904.

The AA 1810 may perform a second synchronization procedure 1906 with the SMF 1808 to synchronize the SMF 1808. The second synchronization procedure 1906 may include the authentication result produced in 1828. The SMF 1808 may determine whether the UE 1802 has been authenticated and/or is authorized to access the SMF 1808.

AA may share the authentication result right after the element 9, or only after when UE is establishing other NAS connections, e.g., after element 14. For example, while the second synchronization procedure 1906 is illustrated as being performed in response to the authentication result being produced in the illustrated embodiment, it should be understood that the second synchronization procedure 1906 may be performed in response to a receiving a request from the SMF 1808 in other embodiments.

Element 12, UE and AMF set up the NAS AMS connection. For example, the AA 1810 may store the UE calculation result and/or the authentication result in 1908. The UE 1802 and the AMF 1806 may establish a NAS-AMF connection in 1908 and/or based on identification of the NAS-AMF connection response 1904 by the UE 1802.

Element 13, UE triggered NAS-SMF connection establishment. For example, the UE 1802 may generate and transmit an NAS-SMF connection request 1910 to the SMF 1808 to initiate establishment of an NAS-SMF connection with the SMF 1808. The NAS-SMF connection request 1910 may include the UE ID corresponding to the UE 1802

Element 14, SMF checks the authentication result received from AA in element 10. SMF may send a request to AA to fetch the authentication result if AA did not share the Authentication result before. For example, the SMF 1808 may determine whether the SMF 1808 has the authentication result stored in 1912, the authentication result received from the AA 1810. If the SMF 1808 determines that the SMF 1808 has the authentication result stored, the SMF 1808 may determine whether the UE 1802 has been authenticated and/or whether the UE 1802 is authorized to access the SMF 1808 based on the authentication result. If the SMF 1808 determines that the SMF 1808 does not have the authentication result stored, the SMF 1808 may request the authentication result from the AA 1810 in 1912, and determine whether the UE 1802 has been authenticated and/or whether the UE 1802 is authorized to access the SMF 1808 based on the authentication result received from the AA 1810.

Element 15, if the verification in step 14 is successful, SMF will accept the connection request, otherwise, SMF will reject. For example, the SMF 1808 may generate an NAS-SMF connection response 1914 that indicates whether the SMF 1808 will accept or reject the connection with the UE 1802 based on the results of 1912. The SMF 1808 may transmit the NAS-SMF connection response to the UE 1802. If the NAS-SMF connection response 1914 indicates that the SMF 1808 will accept the connection with the UE 1802, a NAS-SMF connection may be established between the UE 1802 and the SMF 1808.

While the call flow representation 1800 illustrates an order of the operations within the call flow, it should be understood that one or more of the operations may be performed in a different order and/or one or more of the operations may be performed concurrently in embodiments. Further, it should be understood that one or more of the operations may be omitted from and/or one or more additional operations may be added in other embodiments.

Some embodiments may describe different authentication for different NAS connections, which may be referred to as option 2.

Option 2 may have different authentication procedures for different NAS connections. The authentication procedure may be performed for every NAS connection. Even though the authentication is performed by a central entity, the procedure may be performed for every NAS connection. UE may perform authentication every time it establishes a NAS-X connection. How long is UE reauthenticated may depend on the network implementation.

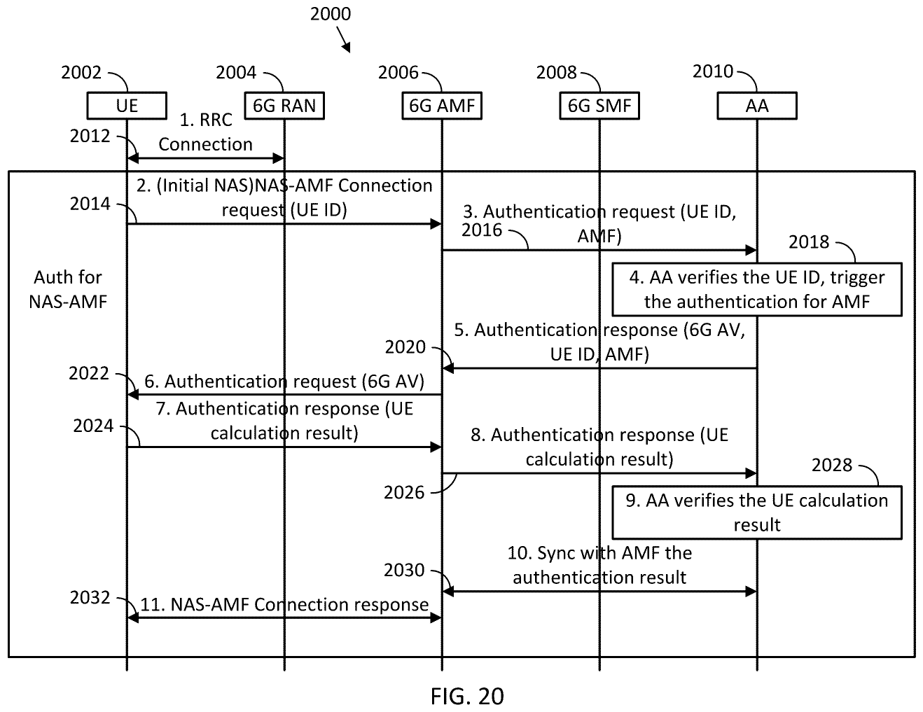

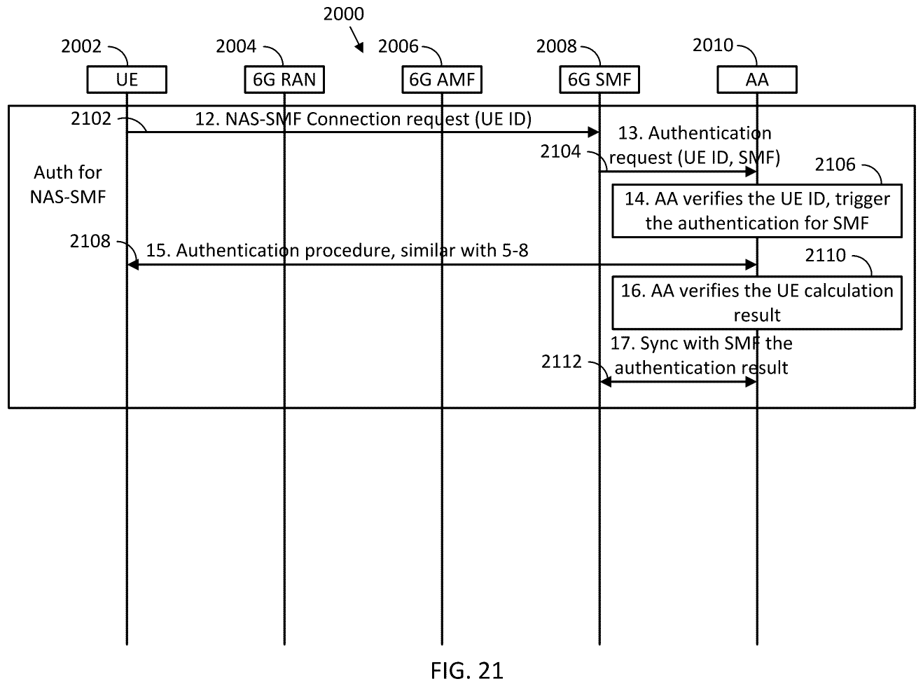

FIG. 20 illustrates a first portion of an example call flow representation 2000 for option 2 in accordance with some embodiments. FIG. 21 illustrates a second portion of the example call flow representation 2000 for option 2 in accordance with some embodiments. The call flow representation 2000 may be performed by a portion of system, such as the system represented by the security design arrangement 1700 (FIG. 17).

The call flow representation 2000 may include a UE 2002. The UE 2002 may include one or more of the features of the UE 2500 (FIG. 25). The call flow representation 2000 may further include a base station 2004. The base station 2004 may include one or more of the features of the gNB 2600 (FIG. 26). The UE 2002 may establish a connection with the base station 2004.

The call flow representation 2000 may include one or more NFs of a core network. In the illustrated embodiment, the call flow representation 2000 includes an AMF 2006 and an SMF 2008 of a core network. The base station 2004 may be coupled to the core network and may be coupled to one or more of the NFs of the core network. In the illustrated embodiment, the base station 2004 is connected to the AMF 2006 and the SMF 2008. The base station 2004 may facilitate connected UEs (including the UE 2002) to establish connections and/or utilize services provided by the NFs (including the AMF 2006 and the SMF 2008).

The call flow representation 2000 may include an AA 2010. The AA 2010 may include one or more of the features of the AA 1614 (FIG. 16) and/or the AA 1714 (FIG. 17). The AA 2010 may provide authentication services for NFs coupled to the AA 2010. The AMF 2006 and the SMF 2008 may be coupled to the AA 2010 in the illustrated embodiment. The AA 2010 may provide authentication services for the AMF 2006 and the SMF 2008. The AA 2010 may be configured in accordance with option 1 where a single authentication procedure may be performed to generate an authentication result that can be shared with multiple NFs of the core network.

Elements of an authentication procedure in accordance with option 2 are illustrated in the call flow representation 2000. Elements 1-10 may be similar with option 2. The difference is that AMF may include the indication “AMF” in the authentication request, so that this authentication procedure is only for NAS-AMF authentication. After the authentication, AA may only share the authentication results with AMF.

For example, elements 1-2, UE may initially connect to the network. The UE 1802 may perform a radio resource control (RRC) connection procedure 2012 to establish a connection with the base station 2004.

It is assumed that the first network entity UE connects to is 6G AMF. For example, the UE 2002 may generate and transmit an NAS-AMF connection request 2014 to the AMF 2006 via the base station 2004. The NAS-AMF connection request 2014 may be an initial NF connection request. It could be other network entities, depending on future 6G network registration procedure. For example, the initial NF connection request can be transmitted to a different NF in other instances. 6G AMF is shown here as an example. UE may include its ID in the request. For example, the NAS-AMF connection request 2014 may include a UE identifier (ID) corresponding to the UE 2002. The ID could be a subscription concealed identifier (SUCI) or a 6G global unique temporary identifier (GUTI). The UE ID may contain sufficient information on the AA address/home public land mobile network (HPLMN) information, so that AMF could find the correct AA for authentication. For example, the AMF 2006 may determine a proper AA for authentication of the UE 2002 based on the UE ID included in the NAS-AMF connection request 2014.

Element 3, AMF may send the authentication request to AA. For example, the AMF 2006 may determine that the AA 2010 is the proper AA for authentication of the UE 2002 based on the UE ID included in the NAS-AMF connection request 2014. The AMF 2006 may generate and transmit an authentication request 2016 to the AA 2010. The authentication request 2016 may include the UE ID corresponding to the UE 2002 and an indication of the AMF 2006.

Element 4, AA verifies the UE ID. For example, the AA 2010 may verify that it can perform authentication of the UE 2002 based on the UE ID included in the authentication request 2016 in 2018. If successful, AA triggers the authentication procedure. For example, the AA 2010 may initiate an authentication procedure for the UE 2002 based on the AA 2010 determining that it can perform authentication of the UE 2002.

Elements 5-9, 6G AKA. AA may send the authentication vector (AV) to the UE, UE may calculate the result and send it back to AA. For example, the AA 2010 may generate and transmit an authentication response 2020 to AMF 2006 as part of the authentication procedure. The authentication response 2020 may include an AV, the UE ID, and the indication of the AMF 2006.

The AMF 2006 may identify the authentication response 2020 received from the AA 2010. The AMF 2006 may generate an authentication request 2022 based on receiving the authentication response 2020, where the authentication request 2022 may include the AV. The AMF 2006 may determine a UE to which the authentication request 2022 is to be transmitted based on the UE ID included in the authentication response 2020, where the AMF 2006 can determine that the authentication request 2022 is to be transmitted to the UE 2002 in the illustrated embodiment. The AMF 2006 may transmit the authentication request 2022 to the UE 2002.

The UE 2002 may identify the authentication request 2022 received from the AMF 2006. Further, the UE 2002 may identify the AV from the authentication request 2022. The UE 2002 may perform a calculation with the AV to produce a UE calculation result. The UE 2002 may generate and transmit an authentication response 2024 to the AMF 2006 based on the reception of the authentication request 2022. The authentication response 2024 can include the UE calculation result produced by the calculation with the AV.

The AMF 2006 may identify the authentication response 2024 received from the UE 2002. The AMF 2006 may generate and/or transmit an authentication response 2026 to the AA 2010. The authentication response 2026 may include the UE calculation result received in the authentication response 2024.

The AA 2010 may identify the authentication response 2026 received from the AMF 2006. The AA 2010 may verify the UE calculation result and generate an authentication result for the UE 2002 in 2028. For example, the AA 2010 may authenticate the UE 2002 and/or determine whether the UE 2002 is authorized to access the AMF 2006 based on the UE calculation result. The AA 2010 may generate an authentication result for the UE 2002 that indicates whether the UE 2002 has been authenticated and/or whether the UE 2002 is authorized to access the AMF 2006.

Element 10, AA synchronizes the authentication result with 6G AMF, then UE and AMF set up the NAS AMF connection. For example, the AA 2010 may share the authentication result produced in 2028 with the AMF 2006.

The AA 2010 may perform a synchronization procedure 2030 with the AMF 2006 to synchronize the AMF 2006. The synchronization procedure 2030 may include the authentication result produced in 2028. The AMF 2006 may determine whether the UE 2002 has been authenticated and/or is authorized to access the AMF 2006. The AMF 2006 may generate an NAS-AMF connection response 2032 that indicates whether the UE 2002 is provided access to the AMF 2006. The AMF 2006 may transmit the NAS-AMF connection response 2032 to the UE 2002. The UE 2002 may identify the NAS-AMF connection response 2032 and may determine whether the UE 2002 can access the AMF 2006 based on the NAS-AMF connection response 2032.

Elements 12-17, the authentication for NAS-SMF procedure may be performed. SMF may send the authentication request to AA with the indication set to “SMF.” After the authentication, AA may only share the authentication results with SMF.

The UE 2002 may generate and transmit an NAS-SMF connection request 2102 to the SMF 2008 via the base station 2004. UE may include its ID in the request. For example, the NAS-SMF connection request 2102 may include a UE identifier (ID) corresponding to the UE 2002. The ID could be a subscription concealed identifier (SUCI) or a 6G global unique temporary identifier (GUTI). The UE ID may contain sufficient information on the AA address/home public land mobile network (HPLMN) information, so that SMF could find the correct AA for authentication. For example, the SMF 2008 may determine a proper AA for authentication of the UE 2002 based on the UE ID included in the NAS-SMF connection request 2102.

Element 13, SMF may send the authentication request to AA. For example, the SMF 2008 may determine that the AA 2010 is the proper AA for authentication of the UE 2002 based on the UE ID included in the NAS-SMF connection request 2102. The SMF 2008 may generate and transmit an authentication request 2104 to the AA 2010. The authentication request 2104 may include the UE ID corresponding to the UE 2002 and/or an indication of the SMF 2008.

Element 14, AA verifies the UE ID. For example, the AA 2010 may verify that it can perform authentication of the UE 2002 based on the UE ID included in the authentication request 2104 in 2106. If successful, AA triggers the authentication procedure. For example, the AA 2010 may initiate an authentication procedure for the UE 2002 based on the AA 2010 determining that it can perform authentication of the UE 2002.

For element 15, similar operations to element 5-8 may be performed. For example, element 15 may include 6G AKA. AA may send the authentication vector (AV) to the UE, UE may calculate the result and send it back to AA. For example, the AA 2010 may generate and transmit an authentication response to SMF 2008 as part of the authentication procedure. The authentication response may include an AV, the UE ID, and the indication of the SMF 2008.

The SMF 2008 may identify the authentication response received from the AA 2010. The SMF 2008 may generate an authentication request based on receiving the authentication response, where the authentication request may include the AV. The SMF 2008 may determine a UE to which the authentication request is to be transmitted based on the UE ID included in the authentication response, where the SMF 2008 can determine that the authentication request is to be transmitted to the UE 2002 in the illustrated embodiment. The SMF 2008 may transmit the authentication request to the UE 2002.

The UE 2002 may identify the authentication request received from the SMF 2008. Further, the UE 2002 may identify the AV from the authentication request. The UE 2002 may perform a calculation with the AV to produce a UE calculation result. The UE 2002 may generate and transmit an authentication response to the SMF 2008 based on the reception of the authentication request. The authentication response can include the UE calculation result produced by the calculation with the AV.

The SMF 2008 may identify the authentication response received from the UE 2002. The SMF 2008 may generate and/or transmit an authentication response to the AA 2010. The authentication response may include the UE calculation result received in the authentication response.

The AA 2010 may identify the authentication response received from the SMF 2008. The AA 2010 may verify the UE calculation result and generate an authentication result for the UE 2002 in 2110. For example, the AA 2010 may authenticate the UE 2002 and/or determine whether the UE 2002 is authorized to access the SMF 2008 based on the UE calculation result. The AA 2010 may generate an authentication result for the UE 2002 that indicates whether the UE 2002 has been authenticated and/or whether the UE 2002 is authorized to access the SMF 2008.

Element 16, AA synchronizes the authentication result with 6G SMF, then UE and SMF set up the NAS SMF connection. For example, the AA 2010 may share the authentication result produced in 2110 with the SMF 2008.

The AA 2010 may perform a synchronization procedure 2112 with the SMF 2008 to synchronize the SMF 2008. The synchronization procedure 2112 may include the authentication result produced in 2110. The SMF 2008 may determine whether the UE 2002 has been authenticated and/or is authorized to access the SMF 2008. The SMF 2008 may generate an NAS-SMF connection response that indicates whether the UE 2002 is provided access to the SMF 2008. The SMF 2008 may transmit the NAS-SMF connection response to the UE 2002. The UE 2002 may identify the NAS-SMF connection response and may determine whether the UE 2002 can access the SMF 2008 based on the NAS-SMF connection response.

For authentication procedure between UE and other NEs, every NE will contact AA for an independent authentication procedure, similar with elements 12-17. For example, each NF may perform the same authentication procedure for establishing an NAS-X connection with the NF, as described in relation to the AMF 2006 and the SMF 2008.

Comparison between option 1 and 2. Option 1 may be simpler, less cost for the UE and network. However, for the network entity that UE rarely connect, the authentication result it receives may be out of date.

Option 2 may be more independent authentication procedures, and every network entity could get the fresh authentication result for this NAS connection. However it may increase the computation cost for UE and the network.

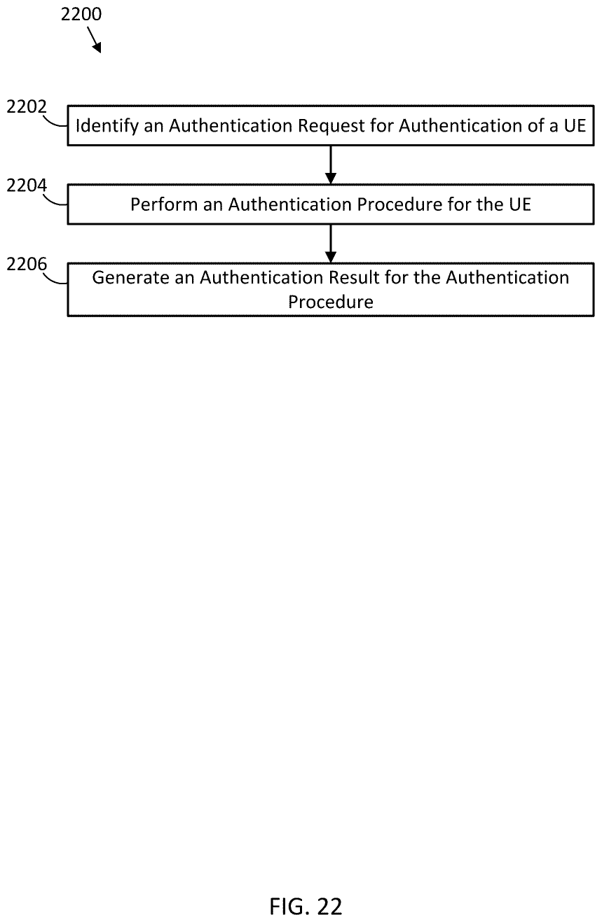

FIG. 22 illustrates an example procedure 2200 for performing an authentication procedure for direct NAS connections in accordance with some embodiments. The procedure 2200 may be performed by an AA, such as the AA 1614 (FIG. 16), the AA 1714 (FIG. 17), the AA 1810 (FIG. 18), and/or the AA 2010 (FIG. 20). In some embodiments, the AA may be an AUSF, where the procedure 2200 may be performed by the AUSF.

The procedure 2200 may include identifying an authentication request for authentication of a UE in 2202. For example, the AA may identify an authentication request for authentication of a UE received from an NF of a network. The UE may be configured for establishing direct NAS connections to two or more NFs of the network.

The procedure 2200 may include performing an authentication procedure for the UE in 2204.

In some embodiments, performing the authentication procedure may include verifying a UE ID received within the authentication request. The authentication procedure may further include generating an AV to be provided to the UE. Further, the authentication procedure may include identifying a calculation result received from the UE and verifying the calculation result to authenticate the UE.

The procedure 2200 may include generating an authentication result of the authentication procedure in 2206. For example, the AA may generate an authentication result of the authentication procedure to be provided to at least one of the two or more NFs. In some embodiments, the authentication result may be to be provided to at least two NFs of the two or more NFs. In some embodiments, the authentication result may be to be provided to all of the two or more NFs.

In some embodiments, the authentication result may be to be provided only to the NF. In some of these embodiments, the procedure 2200 may further include identifying an NF ID corresponding to the NF within the authentication request, wherein the authentication result is to be provided to only the NF based at least in part on the identification of the NF ID within the authentication request.

In some of the embodiments where the authentication result is to be provided only to the NF, the NF may include a first NF. Further, the authentication request may include a first authentication request. The first authentication request may be for the first NF. The authentication procedure may include a first authentication procedure. The authentication result may include a first authentication result. The procedure 2200 may further include identifying a second authentication request for the UE received from a second NF of the two or more NFs. The procedure 2200 may include performing a second authentication procedure for the UE for the second NF. Further, the procedure 2200 may include generating a second authentication result of the second authentication procedure to be provided to the NF. Further, the procedure 2200 may include identifying a first NF ID corresponding to the first NF within the first authentication request in some embodiments. In some embodiments, the procedure 2200 may include identifying a first NF ID corresponding to the first NF within the first authentication request and identifying a second NF ID corresponding to the second NF within the second authentication request.

While FIG. 22 may arguably imply an order of the operations of the procedure 2200, it should be understood that one or more of the operations may be performed in a different order and/or one or more of the operations may be performed concurrently in embodiments. Further, it should be understood that one or more of the operations may be omitted from and/or one or more additional operations may be added to the procedure 2200 in other embodiments.

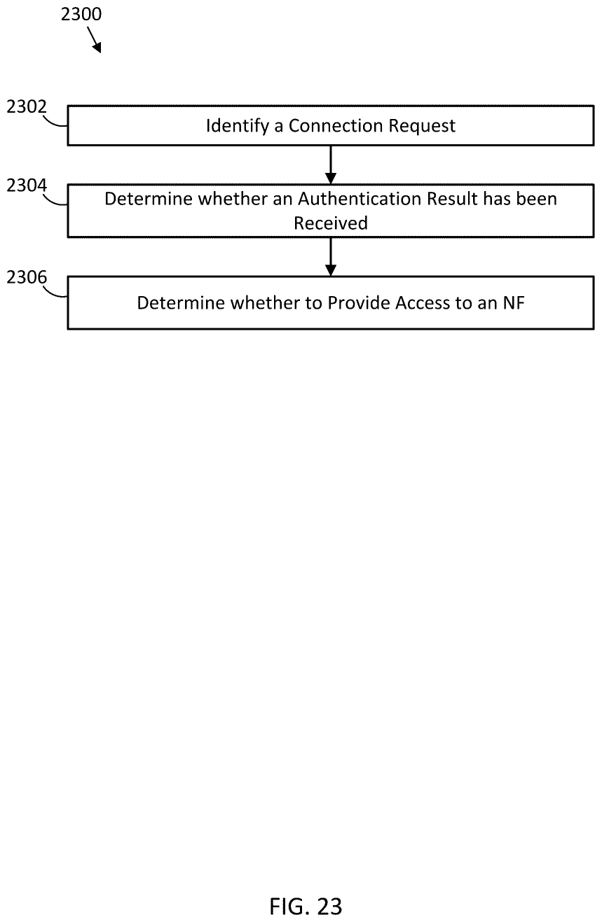

FIG. 23 illustrates an example procedure 2300 for determining whether to provide access to an NF based at least in part on an authentication result in accordance with some embodiments. The procedure 2300 may be performed by an NF, such as the AMFs, the SMFs, the SMSFs, and/or other NFs described throughout this disclosure. For example, a core network implementing the NFs may perform the procedure 2300.

The procedure 2300 may include identifying a connection request in 2302. For example, the NF may identify a connection request from a UE. The UE may be configured for establishing direct NAS connections to two or more NFs of a network.

The procedure 2300 may include determining whether an authentication result has been received in 2304. For example, the NF may determine whether an authentication result has been received for the UE.

The procedure 2300 may include determining whether to provide access to an NF in 2306. For example, the NF may determine whether to provide access to an NF based at least in part on whether the authentication result has been received.

In some embodiments, the NF may include a first NF. Determining whether the authentication result has been received may include determining that the authentication result has been received. The authentication result may have been generated during an authentication result may have been generated during an authentication procedure performed for the UE when accessing a second NF of the two or more NFs.

In some of these embodiments, determining whether to provide access to the first NF may include determining that the authentication result indicates that the UE has been authenticated for accessing the NF. Further, determining whether to provide access to the first NF may include determining to provide access to the first NF based at least in part on the authentication result indicating that the UE has been authenticated for accessing the first NF in some embodiments.

In some embodiments, the NF may include a first NF. Determining whether the authentication result has been received may include determining that the authentication result has not been received in some embodiments. In some embodiments, the procedure 2300 may include generating an authentication request for transmission to an authentication entity to perform an authentication procedure for the UE. The authentication entity may be an AA. The authentication request may cause the authentication entity to provide the authentication result to the first NF and at least one other NF of the two or more NFs.

In some embodiments, the NF may include a first NF. Determining whether the authentication result has been received may include determining that the authentication result has not been received in some embodiments. In some embodiments, the procedure 2300 may include generating an authentication request for transmission to an authentication entity to perform an authentication procedure for the UE. The authentication entity may be an AA. The authentication request may cause the authentication entity to provide the authentication result to the two or more NFs.

In some embodiments, determining whether the authentication result has been received may include determining that the authentication result has not been received. The procedure 2300 may include generating an authentication request with an identifier of the NF for transmission to an authentication entity to perform an authentication procedure for the UE to access the NF in some embodiments. The authentication entity may be an AA. In some of these embodiments, the authentication request may cause the authentication entity to provide the authentication request only to the NF.

While FIG. 23 may arguably imply an order of the operations of the procedure 2300, it should be understood that one or more of the operations may be performed in a different order and/or one or more of the operations may be performed concurrently in embodiments. Further, it should be understood that one or more of the operations may be omitted from and/or one or more additional operations may be added to the procedure 2300 in other embodiments.

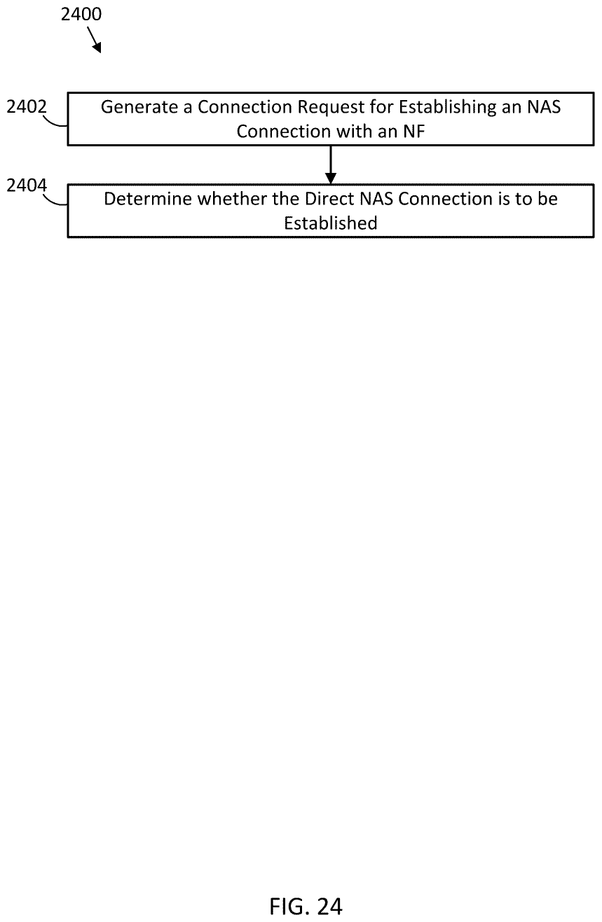

FIG. 24 illustrates an example procedure 2400 for requesting establishment of a directed NAS connection with an NF in accordance with some embodiments. The procedure 2400 may be performed by a UE, such as the UE 2500 (FIG. 25).

The procedure 2400 may include generating a connection request for establishing an NAS connection with an NF. For example, the UE may generate a connection request for establishing a direct NAS connection with an NF of a network. The connection request may be for transmission to the NF. The NF may be included in two or more NFs of the network with which direct NAS connections can be established. The connection request may cause an authentication procedure to be performed for at least the NF.

In some embodiments, the connection request may cause an authentication result of the authentication procedure to be provided only to the NF. The connection request may cause an authentication result of the authentication procedure to be provided to the two or more NFs in some embodiments. In some embodiments, the NF may include a first NF and the connection request may cause an authentication result of the authentication procedure to be provided to the first NF and a second NF of the two or more NFs.

The procedure 2400 may include determining whether the direct NAS connection is to be established. For example, the UE may determine whether the direct NAS connection is to be established based at least in part on a connection response to the connection request.

In some embodiments, the procedure 2400 may further include identifying an authentication vector received from the NF and performing a calculation with the authentication vector to produce a calculation result. The procedure 2400 may generate an authentication response including the calculation result to be provided to the NF in some embodiments.

In some of these embodiments, the NF may include a first NF. The authentication vector may include a first authentication vector. The calculation may include a first calculation. The calculation result may include a first calculation result. The authentication response may include a first authentication response. In some embodiments, the procedure 2400 may further include identifying a second authentication vector received from a second NF of the two or more NFs. The procedure 2400 may further include performing a second calculation with the second authentication vector to produce a second calculation result in some embodiments. In some embodiments, the procedure 2400 may include generating a second authentication response including the second calculation result to be provided to the second NF.

While FIG. 24 may arguably imply an order of the operations of the procedure 2400, it should be understood that one or more of the operations may be performed in a different order and/or one or more of the operations may be performed concurrently in embodiments. Further, it should be understood that one or more of the operations may be omitted from and/or one or more additional operations may be added to the procedure 2400 in other embodiments.

FIG. 25 illustrates an example UE 2500 in accordance with some embodiments. The UE 2500 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 2500 may be a RedCap UE or NR-Light UE.

The UE 2500 may include processors 2504, RF interface circuitry 2508, memory/storage 2512, user interface 2516, sensors 2520, driver circuitry 2522, power management integrated circuit (PMIC) 2524, antenna structure 2526, and battery 2528. The components of the UE 2500 may be implemented as integrated circuits (ICs), portions thereof, discrete electronic devices, or other modules, logic, hardware, software, firmware, or a combination thereof. The block diagram of FIG. 25 is intended to show a high-level view of some of the components of the UE 2500. However, some of the components shown may be omitted, additional components may be present, and different arrangement of the components shown may occur in other implementations.

The components of the UE 2500 may be coupled with various other components over one or more interconnects 2532, which may represent any type of interface, input/output, bus (local, system, or expansion), transmission line, trace, optical connection, etc. that allows various circuit components (on common or different chips or chipsets) to interact with one another.

The processors 2504 may include processor circuitry such as, for example, baseband processor circuitry (BB) 2504A, central processor unit circuitry (CPU) 2504B, and graphics processor unit circuitry (GPU) 2504C. The processors 2504 may include any type of circuitry or processor circuitry that executes or otherwise operates computer-executable instructions, such as program code, software modules, or functional processes from memory/storage 2512 to cause the UE 2500 to perform operations as described herein. The processors 2504 may further include interface circuitry 2504D. The interface circuitry 2504D may communicatively couple one or more of the BB 2504A, the CPU 2504B, and/or the GPU 2504C to each other and/or to other components of the UE 2500, such as the memory/storage 2512, the sensors 2520, the driver circuitry 2522, the PMIC 2524, the user interface 2516, the battery 2528, and/or the RF interface circuitry 2508. The interface circuitry 2504D may comprise wired connections (such as traces, vias, and/or wires) or wireless connections to facilitate the communicative coupling.

In some embodiments, the baseband processor circuitry 2504A may access a communication protocol stack 2536 in the memory/storage 2512 to communicate over a 3GPP compatible network. In general, the baseband processor circuitry 2504A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 2508.

The baseband processor circuitry 2504A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 2512 may include one or more non-transitory, computer-readable media that includes instructions (for example, communication protocol stack 2536) that may be executed by one or more of the processors 2504 to cause the UE 2500 to perform various operations described herein. The memory/storage 2512 include any type of volatile or non-volatile memory that may be distributed throughout the UE 2500. In some embodiments, some of the memory/storage 2512 may be located on the processors 2504 themselves (for example, L1 and L2 cache), while other memory/storage 2512 is external to the processors 2504 but accessible thereto via a memory interface. The memory/storage 2512 may include any suitable volatile or non-volatile memory such as, but not limited to, dynamic random access memory (DRAM), static random access memory (SRAM), eraseable programmable read only memory (EPROM), electrically eraseable programmable read only memory (EEPROM), Flash memory, solid-state memory, or any other type of memory device technology.

The RF interface circuitry 2508 may include transceiver circuitry and radio frequency front module (RFEM) that allows the UE 2500 to communicate with other devices over a radio access network. The RF interface circuitry 2508 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 2526 and proceed to filter and amplify (with a low-noise amplifier) the signal. The signal may be provided to a receiver of the transceiver that down-converts the RF signal into a baseband signal that is provided to the baseband processor of the processors 2504.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 2526.

In various embodiments, the RF interface circuitry 2508 may be configured to transmit/receive signals in a manner compatible with NR access technologies.

The antenna structure 2526 may include antenna elements to convert electrical signals into radio waves to travel through the air and to convert received radio waves into electrical signals. The antenna elements may be arranged into one or more antenna panels. The antenna structure 2526 may have antenna panels that are omnidirectional, directional, or a combination thereof to enable beamforming and multiple input, multiple output communications. The antenna structure 2526 may include microstrip antennas, printed antennas fabricated on the surface of one or more printed circuit boards, patch antennas, phased array antennas, etc. The antenna structure 2526 may have one or more panels designed for specific frequency bands including bands in FR1 or FR2.

The user interface 2516 includes various input/output (I/O) devices designed to enable user interaction with the UE 2500. The user interface 2516 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 2500.

The sensors 2520 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 2522 may include software and hardware elements that operate to control particular devices that are embedded in the UE 2500, attached to the UE 2500, or otherwise communicatively coupled with the UE 2500. The driver circuitry 2522 may include individual drivers allowing other components to interact with or control various input/output (I/O) devices that may be present within, or connected to, the UE 2500. For example, driver circuitry 2522 may include a display driver to control and allow access to a display device, a touchscreen driver to control and allow access to a touchscreen interface, sensor drivers to obtain sensor readings of sensor circuitry 2520 and control and allow access to sensor circuitry 2520, drivers to obtain actuator positions of electro-mechanic components or control and allow access to the electro-mechanic components, a camera driver to control and allow access to an embedded image capture device, audio drivers to control and allow access to one or more audio devices.

The PMIC 2524 may manage power provided to various components of the UE 2500. In particular, with respect to the processors 2504, the PMIC 2524 may control power-source selection, voltage scaling, battery charging, or DC-to-DC conversion.

In some embodiments, the PMIC 2524 may control, or otherwise be part of, various power saving mechanisms of the UE 2500. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 2500 may power down for brief intervals of time and thus save power. If there is no data traffic activity for an extended period of time, then the UE 2500 may transition off to an RRC_Idle state, where it disconnects from the network and does not perform operations such as channel quality feedback, handover, etc. The UE 2500 goes into a very low power state and it performs paging where again it periodically wakes up to listen to the network and then powers down again. The UE 2500 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 2528 may power the UE 2500, although in some examples the UE 2500 may be mounted deployed in a fixed location, and may have a power supply coupled to an electrical grid. The battery 2528 may be a lithium ion battery, a metal-air battery, such as a zinc-air battery, an aluminum-air battery, a lithium-air battery, and the like. In some implementations, such as in vehicle-based applications, the battery 2528 may be a typical lead-acid automotive battery.

FIG. 26 illustrates an example gNB 2600 in accordance with some embodiments. The gNB 2600 may include processors 2604, RF interface circuitry 2608, core network (CN) interface circuitry 2612, memory/storage circuitry 2616, and antenna structure 2626.

The components of the gNB 2600 may be coupled with various other components over one or more interconnects 2628.

The processors 2604, RF interface circuitry 2608, memory/storage circuitry 2616 (including communication protocol stack 2610), antenna structure 2626, and interconnects 2628 may be similar to like-named elements shown and described with respect to FIG. 25.

The processors 2604 may further include interface circuitry 2604D. The interface circuitry 2604D may communicatively couple one or more of the BB 2604A, the CPU 2604B, and/or the GPU 2604C to each other and/or to other components of the gNB 2600, such as the memory/storage circuitry 2616, the CN interface circuitry 2612, and/or the RAN interface circuitry. The interface circuitry 2604D may comprise wired connections (such as traces, vias, and/or wires) or wireless connections to facilitate the communicative coupling.

The CN interface circuitry 2612 may provide connectivity to a core network, for example, a 5th Generation Core network (5GC) using a 5GC-compatible network interface protocol such as carrier Ethernet protocols, or some other suitable protocol. Network connectivity may be provided to/from the gNB 2600 via a fiber optic or wireless backhaul. The CN interface circuitry 2612 may include one or more dedicated processors or FPGAs to communicate using one or more of the aforementioned protocols. In some implementations, the CN interface circuitry 2612 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method comprising identifying an authentication request for authentication of a user equipment (UE) received from a network function (NF) of a network, the UE configured for establishing direct non-access stratum (NAS) connections to two or more NFs of the network, performing an authentication procedure for the UE, and generating an authentication result of the authentication procedure to be provided to at least one of the two or more NFs.

Example 2 may include the method of example 1, wherein the authentication result is to be provided to at least two NFs of the two or more NFs.

Example 3 may include the method of example 1, wherein the authentication result is to be provided to all of the two or more NFs.

Example 4 may include the method of example 1, wherein performing the authentication procedure includes verifying a UE identifier (ID) received within the authentication request, generating an authentication vector (AV) to be provided to the UE, identifying a calculation result received from the UE, and verifying the calculation result to authenticate the UE.

Example 5 may include the method of example 1, wherein the authentication result is to be provided to only the NF.

Example 6 may include the method of example 5, further comprising identifying an NF identifier (ID) corresponding to the NF within the authentication request, wherein the authentication result is to be provided to only the NF based at least in part on the identification of the NF ID within the authentication request.

Example 7 may include the method of example 5, wherein the NF includes a first NF, wherein the authentication request includes a first authentication request, wherein the first authentication request is for the first NF, wherein the authentication procedure includes a first authentication procedure, wherein the authentication result includes a first authentication result, and wherein the method further comprises identifying a second authentication request for the UE received from a second NF of the two or more NFs, performing a second authentication procedure for the UE for the second NF, and generating a second authentication result of the second authentication procedure to be provided to the second NF.

Example 8 may include the method of example 7, further comprising identifying a first NF identifier (ID) corresponding to the first NF within the first authentication request, and identifying a second NF ID corresponding to the second NF within the second authentication request.

Example 9 may include the method of example 1, wherein the method is performed by an authentication server function (AUSF).

Example 10 may include a method comprising identifying a connection request from a user equipment (UE), the UE configured for establishing direct non-access stratum (NAS) connections to two or more network functions (NFs) of a network, determining whether an authentication result has been received for the UE, and determining whether to provide access to a network function (NF) based at least in part on whether the authentication result has been received.

Example 11 may include the method of example 10, wherein the NF includes a first NF, and wherein determining whether the authentication result has been received includes determining that the authentication result has been received, the authentication result having been generated during an authentication procedure performed for the UE when accessing a second NF of the two or more NFs.

Example 12 may include the method of example 11, wherein determining whether to provide access to the first NF includes determining that the authentication result indicates that the UE has been authenticated for accessing the first NF, and determining whether to provide access to the first NF includes determining to provide access to the first NF based at least in part on the authentication result indicating that the UE has been authenticated for accessing the first NF.

Example 13 may include the method of example 10, wherein the NF includes a first NF, wherein determining whether the authentication result has been received includes determining that the authentication result has not been received, and wherein the method further comprises generating an authentication request for transmission to an authentication entity to perform an authentication procedure for the UE, wherein the authentication request is to cause the authentication entity to provide the authentication result to the first NF and at least one other NF of the two or more NFs.

Example 14 may include the method of example 10, wherein the NF includes a first NF, wherein determining whether the authentication result has been received includes determining that the authentication result has not been received, and wherein the method further comprises generating an authentication request for transmission to an authentication entity to perform an authentication procedure for the UE, wherein the authentication request is to cause the authentication entity to provide the authentication result to the two or more NFs.

Example 15 may include the method of example 10, wherein determining whether the authentication result has been received includes determining that the authentication result has not been received, and wherein the method further comprises generating an authentication request with an identifier of the NF for transmission to an authentication entity to perform an authentication procedure for the UE to access the NF.

Example 16 may include the method of example 15, wherein the authentication request is to cause the authentication entity to provide the authentication request only to the NF.

Example 17 may include a method comprising generating a connection request for establishing a direct non-access (NAS) connection with a network function (NF) of a network, the connection request for transmission to the NF, the NF included in two or more NFs of the network with which direct NAS connections can be established, and the connection request to cause an authentication procedure to be performed for at least the NF, and determining whether the direct NAS connection is to be established based at least in part on a connection response to the connection request.

Example 18 may include the method of example 17, wherein the connection request is to cause an authentication result of the authentication procedure to be provided only to the NF.

Example 19 may include the method of example 17, wherein the connection request is to cause an authentication result of the authentication procedure to be provided to the two or more NFs.

Example 20 may include the method of example 17, wherein the NF includes a first NF, and wherein the connection request is to cause an authentication result of the authentication procedure to be provided to the first NF and a second NF of the two or more NFs.

Example 21 may include the method of example 17, further comprising identifying an authentication vector received from the NF, performing a calculation with the authentication vector to produce a calculation result, and generating an authentication response including the calculation result to be provided to the NF.

Example 22 may include the method of example 21, wherein the NF includes a first NF, wherein the authentication vector includes a first authentication vector, wherein the calculation includes a first calculation, wherein the calculation result includes a first calculation result, wherein the authentication response includes a first authentication response, and wherein the method further comprises identifying a second authentication vector received from a second NF of the two or more NFs, performing a second calculation with the second authentication vector to produce a second calculation result, and generating a second authentication response including the second calculation result to be provided to the second NF.

Example 23 may include an apparatus comprising means to perform one or more elements of a method described in or related to any of examples 1-22, or any other method or process described herein.

Example 24 may include one or more non-transitory computer-readable media comprising instructions to cause an electronic device, upon execution of the instructions by one or more processors of the electronic device, to perform one or more elements of a method described in or related to any of examples 1-22, or any other method or process described herein.

Example 25 may include an apparatus comprising logic, modules, or circuitry to perform one or more elements of a method described in or related to any of examples 1-22, or any other method or process described herein.

Example 26 may include a method, technique, or process as described in or related to any of examples 1-22, or portions or parts thereof.

Example 27 may include an apparatus comprising: one or more processors and one or more computer-readable media comprising instructions that, when executed by the one or more processors, cause the one or more processors to perform the method, techniques, or process as described in or related to any of examples 1-22, or portions thereof.

Example 28 may include a signal as described in or related to any of examples 1-22, or portions or parts thereof.

Example 29 may include a datagram, information element, packet, frame, segment, PDU, or message as described in or related to any of examples 1-22, or portions or parts thereof, or otherwise described in the present disclosure.

Example 30 may include a signal encoded with data as described in or related to any of examples 1-22, or portions or parts thereof, or otherwise described in the present disclosure.

Example 31 may include a signal encoded with a datagram, IE, packet, frame, segment, PDU, or message as described in or related to any of examples 1-22, or portions or parts thereof, or otherwise described in the present disclosure.

Example 32 may include an electromagnetic signal carrying computer-readable instructions, wherein execution of the computer-readable instructions by one or more processors is to cause the one or more processors to perform the method, techniques, or process as described in or related to any of examples 1-22, or portions thereof.

Example 33 may include a computer program comprising instructions, wherein execution of the program by a processing element is to cause the processing element to carry out the method, techniques, or process as described in or related to any of examples 1-22, or portions thereof.

Example 34 may include a signal in a wireless network as shown and described herein.

Example 35 may include a method of communicating in a wireless network as shown and described herein.

Example 36 may include a system for providing wireless communication as shown and described herein.

Example 37 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory, computer-readable media having instructions that, when executed, cause processing circuitry to:
identify an authentication request for authentication of a user equipment (UE) received from a network function (NF) of a network, the UE configured for establishing direct non-access stratum (NAS) connections to two or more NFs of the network;
perform an authentication procedure for the UE; and
generate an authentication result of the authentication procedure to be provided to at least one of the two or more NFs.

2. The one or more non-transitory, computer-readable media of claim 1, wherein the authentication result is to be provided to at least two NFs of the two or more NFs.

3. The one or more non-transitory, computer-readable media of claim 1, wherein the authentication result is to be provided to all of the two or more NFs.

4. The one or more non-transitory, computer-readable media of claim 1, wherein to perform the authentication procedure includes to:
verify a UE identifier (ID) received within the authentication request;
generate an authentication vector (AV) to be provided to the UE;
identify a calculation result received from the UE; and
verify the calculation result to authenticate the UE.

5. The one or more non-transitory, computer-readable media of claim 1, wherein the authentication result is to be provided to only the NF.

6. The one or more non-transitory, computer-readable media of claim 5, wherein the instructions, when executed, further cause the processing circuitry to:
identify an NF identifier (ID) corresponding to the NF within the authentication request, wherein the authentication result is to be provided to only the NF based at least in part on the identification of the NF ID within the authentication request.

7. The one or more non-transitory, computer-readable media of claim 5, wherein the NF includes a first NF, wherein the authentication request includes a first authentication request, wherein the first authentication request is for the first NF, wherein the authentication procedure includes a first authentication procedure, wherein the authentication result includes a first authentication result, and wherein the instructions, when executed, further cause the processing circuitry to:
identify a second authentication request for the UE received from a second NF of the two or more NFs;
perform a second authentication procedure for the UE for the second NF; and
generate a second authentication result of the second authentication procedure to be provided to the second NF.

8. The one or more non-transitory, computer-readable media of claim 7, wherein the instructions, when executed, further cause the processing circuitry to:
identify a first NF identifier (ID) corresponding to the first NF within the first authentication request; and
identify a second NF ID corresponding to the second NF within the second authentication request.

9. The one or more non-transitory, computer-readable media of claim 1, wherein an authentication server function (AUSF) is to provide the instructions to cause the processing circuitry to perform the operations.

10. A method comprising:
identifying a connection request from a user equipment (UE), the UE configured for establishing direct non-access stratum (NAS) connections to two or more network functions (NFs) of a network;
determining whether an authentication result has been received for the UE; and
determining whether to provide access to a network function (NF) based at least in part on whether the authentication result has been received.

11. The method of claim 10, wherein the NF includes a first NF, and wherein:
determining whether the authentication result has been received includes determining that the authentication result has been received, the authentication result having been generated during an authentication procedure performed for the UE when accessing a second NF of the two or more NFs.

12. The method of claim 11, wherein:
determining whether to provide access to the first NF includes determining that the authentication result indicates that the UE has been authenticated for accessing the first NF; and
determining whether to provide access to the first NF includes determining to provide access to the first NF based at least in part on the authentication result indicating that the UE has been authenticated for accessing the first NF.

13. The method of claim 10, wherein the NF includes a first NF, wherein determining whether the authentication result has been received includes determining that the authentication result has not been received, and wherein the method further comprises:
generating an authentication request for transmission to an authentication entity to perform an authentication procedure for the UE, wherein the authentication request is to cause the authentication entity to provide the authentication result to the first NF and at least one other NF of the two or more NFs.

14. The method of claim 10, wherein the NF includes a first NF, wherein determining whether the authentication result has been received includes determining that the authentication result has not been received, and wherein the method further comprises:
generating an authentication request for transmission to an authentication entity to perform an authentication procedure for the UE, wherein the authentication request is to cause the authentication entity to provide the authentication result to the two or more NFs.

15. The method of claim 10, wherein determining whether the authentication result has been received includes determining that the authentication result has not been received, and wherein the method further comprises:
generating an authentication request with an identifier of the NF for transmission to an authentication entity to perform an authentication procedure for the UE to access the NF.

16. An apparatus comprising:
processing circuitry to:
generate a connection request for establishing a direct non-access (NAS) connection with a network function (NF) of a network, the connection request for transmission to the NF, the NF included in two or more NFs of the network with which direct NAS connections can be established, and the connection request to cause an authentication procedure to be performed for at least the NF; and
determine whether the direct NAS connection is to be established based at least in part on a connection response to the connection request; and
interface circuitry coupled with the processing circuitry, the interface circuitry to enable communication.

17. The apparatus of claim 16, wherein the connection request is to cause an authentication result of the authentication procedure to be provided only to the NF.

18. The apparatus of claim 16, wherein the connection request is to cause an authentication result of the authentication procedure to be provided to the two or more NFs.

19. The apparatus of claim 16, wherein the NF includes a first NF, and wherein the connection request is to cause an authentication result of the authentication procedure to be provided to the first NF and a second NF of the two or more NFs.

20. The apparatus of claim 16, wherein the processing circuitry is further to:
identify an authentication vector received from the NF;
perform a calculation with the authentication vector to produce a calculation result; and
generate an authentication response including the calculation result to be provided to the NF.
